(19) United States
(12) Patent Application Publication
(10) Pub. No.: US 2026/0108809 A1
(43) Pub. Date: Apr. 23, 2026

(54) VIDEO RECAPPING KEY EVENTS IN GAME PLAY OF VIDEO GAME GENERATED USING ARTIFICIAL INTELLIGENCE

(71) Applicant: Sony Interactive Entertainment Inc., Tokyo (JP)

(72) Inventors: Grant Young, San Mateo, CA (US); Isaiah Webb, San Mateo, CA (US); Angela Webb, San Mateo, CA (US)

(21) Appl. No.: 18/921,916

(22) Filed: Oct. 21, 2024

(51) Int. Cl. A63F 13/497; A63F 13/52; A63F 13/54

(52) U.S. Cl. CPC A63F 13/497; A63F 13/52; A63F 13/54

(57) ABSTRACT

A method includes accessing game state data for a game play of a video game. The method including executing an artificial intelligence (AI) model using the game state data to identify key events in the game play. The method including executing the AI model using the game state data to curate a storyline for a video recapping the game play for a selected duration. The method including executing the AI model using the game state data to select and arrange scenes from the game play following the storyline, wherein each scene includes video frames from the game play. The method including regenerating the scenes using the game state of the game play. The method including executing the AI model to generate the video recapping the game play including the scenes arranged to follow the storyline. The method including displaying the video recapping the game play in a user interface.

### TECHNICAL FIELD

The present disclosure is related to generating a video recapping a game play of a video game by a user using artificial intelligence. In particular, artificial intelligence is used to identify key events in the game play, and incorporate those key events along with relevant information about the game play into a video. In that manner, a user that is coming back to play a video game after an extended period is reminded on how to play the video game.

### BACKGROUND OF THE DISCLOSURE

Video games and/or gaming applications and their related industries (e.g., video gaming) are extremely popular and represent a large percentage of the worldwide entertainment market. Video games are played anywhere and at any time using various types of platforms, including gaming consoles, desktop computers, laptop computers, mobile phones, tablet computers, etc.

Often, a player has questions regarding a video game, especially when returning to playing the video game after an extended period of inactivity. These questions may involve remembering basic facts, such as remembering the name of an object or character, or the current level, etc. The questions may be more complex, and involve remembering the story arc of the video game, or even how to play the video game as the player may have even forgotten basic moves or tasks undertaken. Varying degrees of complexity and amount of questions arise depending on the when the last interaction with the video game occurred and/or how deeply the player has progressed through the video game. For example, the questions may become more complex the longer the period of inactivity.

It is in this context that embodiments of the disclosure arise.

### SUMMARY

Embodiments of the present disclosure relate to providing a reminder to a user on how to play a video game to include generating a video recap of key events in a game play incorporating scenes from that game play using artificial intelligence. The same process can be used to recap important moves unlocked during the game play, and provide a tutorial that enables the user to manually replay those moves from a scene in the game play by the user. In that manner, a user that has forgotten what occurred during a game play of a video game, such as when picking up playing a video game after an extended period of time, can be reminded about their game play (e.g., names of characters and/or objects, tasks undertaken, the overall story arc of the video game, and the overall progression of the video game in their game play).

In one embodiment, a method is disclosed. The method including accessing a plurality of game state data for a game play of a video game. The method including executing an artificial intelligence (AI) model using the game state data to identify a plurality of key events in the game play of the video game. The method including executing the AI model using the game state data to curate a storyline for a video recapping the game play of the video game, wherein the storyline is curated for a selected duration. The method including executing the AI model using the game state data to select and arrange a plurality of scenes from the game play of the video game following the storyline that is curated, wherein each of the plurality of scenes includes one or more video frames from the game play of the video game. The method including regenerating the plurality of scenes using the game state of the game play of the video game. The method including executing the AI model to generate the video recapping the game play of the video game including the plurality of scenes arranged to follow the storyline that is curated. The method including displaying the video recapping the game play of the video game in a user interface.

In another embodiment, a non-transitory computer-readable medium storing a computer program for performing a method is disclosed. The non-transitory computer-readable medium including program instructions for accessing a plurality of game state data for a game play of a video game. The non-transitory computer-readable medium including program instructions for executing an artificial intelligence (AI) model using the game state data to identify a plurality of key events in the game play of the video game. The non-transitory computer-readable medium including program instructions for executing the AI model using the game state data to curate a storyline for a video recapping the game play of the video game, wherein the storyline is curated for a selected duration. The non-transitory computer-readable medium including program instructions for executing the AI model using the game state data to select and arrange a plurality of scenes from the game play of the video game following the storyline that is curated, wherein each of the plurality of scenes includes one or more video frames from the game play of the video game. The non-transitory computer-readable medium including program instructions for regenerating the plurality of scenes using the game state of the game play of the video game. The non-transitory computer-readable medium including program instructions for executing the AI model to generate the video recapping the game play of the video game including the plurality of scenes arranged to follow the storyline that is curated. The non-transitory computer-readable medium including program instructions for displaying the video recapping the game play of the video game in a user interface.

In still another embodiment, a computer system is disclosed, wherein the computer system includes a processor and memory coupled to the processor and having stored therein instructions that, if executed by the computer system, cause the computer system to execute a method. The method including accessing a plurality of game state data for a game play of a video game. The method including executing an artificial intelligence (AI) model using the game state data to identify a plurality of key events in the game play of the video game. The method including executing the AI model using the game state data to curate a storyline for a video recapping the game play of the video game, wherein the storyline is curated for a selected duration. The method including executing the AI model using the game state data to select and arrange a plurality of scenes from the game play of the video game following the storyline that is curated, wherein each of the plurality of scenes includes one or more video frames from the game play of the video game. The method including regenerating the plurality of scenes using the game state of the game play of the video game. The method including executing the AI model to generate the video recapping the game play of the video game including the plurality of scenes arranged to follow the storyline that is curated. The method including displaying the video recapping the game play of the video game in a user interface.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1 illustrates a system configured for generating using artificial intelligence a video recapping a game play of a video game by a user, that incorporates scenes from key events in the game play of the user, in accordance with one embodiment of the present disclosure.

FIG. 2 is a flow diagram illustrating a method for generating using artificial intelligence a video recapping a game play of a video game by a user, incorporating scenes from key events in that game play using artificial intelligence, in accordance with one embodiment of the present disclosure.

FIG. 3 is an illustration of a system configured to implement an AI model configured for extracting and classifying key events occurring in and relevant information related to a game play of a video game by a user, and generate a video recapping the game play incorporating scenes from the key events, in accordance with one embodiment of the present disclosure.

FIG. 4 is a block diagram illustrating a RECAP user interface builder configured to generate a video recapping game play of a user playing a video game and user interface including the video recap, and further provide additional services and/or features related to the video recap, in accordance with one embodiment of the present disclosure.

FIG. 5A illustrates a start page for a video game providing access to a RECAP user interface including a video recapping game play of a user playing a video game, in accordance with one embodiment of the present disclosure.

FIG. 5B illustrates a splash page for a RECAP user interface configured to allow a user to set one or more parameters of a video recapping game play of a user playing a video game generated using artificial intelligence, and provide access to the video recap, in accordance with one embodiment of the present disclosure.

FIG. 5C illustrates a RECAP user interface displaying a video recapping game play of a user playing a video game, incorporating scenes from the game play of the user, and further providing access to features enabling replay of a scene or unlocked move from the game play, in accordance with one embodiment of the present disclosure.

FIG. 5D illustrates a user interface enabling a replay of a scene taken from a game play of a video game by a user, in accordance with one embodiment of the present disclosure.

FIG. 5E illustrates a user interface enabling a replay and tutorial of a move unlocked during a game play of a video game by a user, in accordance with one embodiment of the present disclosure.

FIG. 6 illustrates components of an example device that can be used to perform aspects of the various embodiments of the present disclosure.

### DETAILED DESCRIPTION

Although the following detailed description contains many specific details for the purposes of illustration, anyone of ordinary skill in the art will appreciate that many variations and alterations to the following details are within the scope of the present disclosure. Accordingly, the aspects of the present disclosure are set forth without any loss of generality to, and without imposing limitations upon, the claims that follow this description.

Generally speaking, the various embodiments of the present disclosure describe systems and methods for generating a video recap of key events in a game play incorporating scenes from that game play using artificial intelligence, and for recapping important moves unlocked during the game play, and for enabling replay of scenes from the game play, and for enabling replay of pre-generated cutscenes, and for enabling a tutorial including a replay of a move unlocked during the game play. As such, artificial intelligence can be used to remind a user how to play a video game through generation of a video recapping key events in the game play, that incorporates scenes directly from the game play of the user. That is, generation of the video recapping the game play and/or services related to the video are based on the game play of the user, including the skill set achieved during the game play (e.g., unlocked moves of a character). For example, when a user has not played a video game in a while, the generated video provides reminders about how to play and how they played the video game, including what level the user is currently playing in their game play, moves and/or controls unlocked during the game play, characters and/or objects encountered, etc. In particular, the user may access a tutorial that allows for replaying a move, unlocked during the game play, in a scene where the move was performed, and includes instructions on what control buttons to press, the sequence of pressing the control buttons, and/or the intensity and/or magnitude of pressing the control buttons. Also, the user may replay a previous section or scene from their gameplay, such as when a move was recently unlocked but the user has forgotten how to initiate and/or execute the move. The recap services may be prompted upon detection that the user is struggling in their game play of the video game. Also, the recap services may be actively requested by the user, such as when the user is picking up a game after an extended period of inactivity and would like a review on the current state of the game play, and/or a review of the story arc achieved during the game play. In that manner, the user avoids feeling lost when picking up a video game that they may not have played in a while, by getting reacclimated to the video game through the video recapping key events and/or unlocked moves that occurred during the game play, and through physical reminders of how to play the game through replays of scenes and/or moves from the game play. These physical reminders activate memory reflexes on how to play the video game (e.g., relearning to innately perform a sequence of controller inputs to execute a move unlocked during the game play).

Advantages of the methods and systems, configured to generating a video recap of key events in a game play incorporating scenes from that game play using artificial intelligence, include the continuous identification and capture of key events occurring during game play of a user through the analysis of game state data. Further, a storyline can be generated that is unique to the game play of the user, and a video following the storyline can be generated including scenes taken from the game play of the user. In addition, the storyline and video can be dynamically updated as the user progresses further in their game play. As such, instead of viewing a video that generically previews a video game using scenes taken from random game plays, the video recap generated using embodiments of the present disclosure is tailored to the user by incorporating scenes from the game play of the user.

Throughout the specification, the reference to “game” or “video game” or “gaming application” is meant to represent any type of interactive application that is directed through execution of input commands. For illustration purposes only, an interactive application includes applications for gaming, word processing, video processing, video game processing, etc. Also, the terms “virtual world” or “virtual environment” or “metaverse” is meant to represent any type of environment generated by a corresponding application or applications for interaction between a plurality of users in a multi-player session or multi-player gaming session. Furthermore, the term “platform” refers to a combination of hardware and software components providing a set of capabilities in order to execute one or more software applications (e.g., video games). For example, the term “platform” may be used with reference to “devices of a particular platform” or “cross-platform devices.” Moreover, suitable terms introduced above are interchangeable.

With the above general understanding of the various embodiments, example details of the embodiments will now be described with reference to the various drawings.

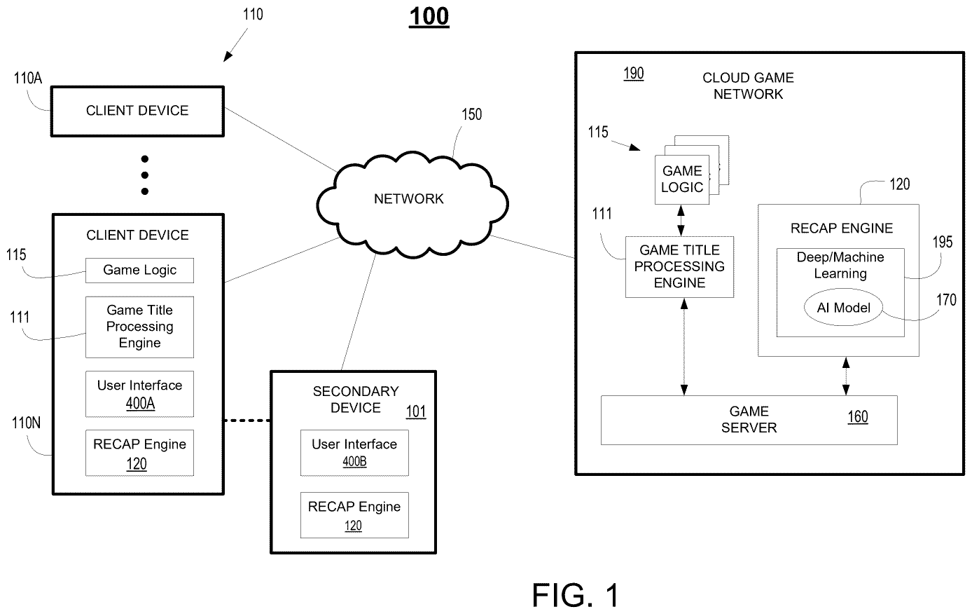

FIG. 1 illustrates a system 100 configured for generating, using artificial intelligence, a video recapping a game play of a video game by a user, that incorporates scenes from key events in the game play of the user, in accordance with one embodiment of the present disclosure. In that manner, the user is able to reacquaint themselves with details of the video game, and more specifically with details of their previous game play of the video game. For instance, when a user has not played the video game after a period of time, and has forgotten where their character is located in a corresponding gaming world, under what task that character should strive to complete, and/or possibly how to have the character initiate a move, the video recapping the game play of the user reminds the user about particulars of the video game previously known to the user.

As shown, system 100 may provide gaming over a network 150 for one or more client devices 110 (e.g., 110A through 110N) of one or more users. In particular, system 100 may be configured to enable users to interact with interaction applications, including providing gaming to users participating in a single-player or multi-player gaming sessions (e.g., participating in a video game in single-player or multi-player mode, or participating in a metaverse generated by an application with other users, etc.) via a cloud game network 190, wherein the game can be executed locally (e.g., on a local client device 110 of a corresponding user) or can be executed remotely from a corresponding client device 110 (e.g., acting as a thin client) of the corresponding user that is playing the video game, in accordance with one embodiment of the present disclosure. In at least one capacity, the cloud game network 190 supports a multi-player gaming session for a group of users, to include delivering and receiving game data of players for purposes of coordinating and/or aligning objects and actions of players within a scene of a gaming world or metaverse, managing communications between user, etc., so that the users in distributed locations participating in a multi-player gaming session can interact with each other in the gaming world or metaverse in real-time. In another capacity, the cloud game network 190 supports multiple users participating in a metaverse.

In some embodiments, the cloud game network 190 may include a plurality of virtual machines (VMs) running on a hypervisor of a host machine, with one or more virtual machines configured to execute a game processor module utilizing the hardware resources available to the hypervisor of the host. It should be noted, that access services, such as providing access to games of the current embodiments, delivered over a wide geographical area often use cloud computing. Cloud computing is a style of computing in which dynamically scalable and often virtualized resources are provided as a service over the internet.

In a multi-player session allowing participation for a group of users to interact within a gaming world or metaverse generated by an application (which may be a video game), some users may be executing an instance of the application locally on a client device (e.g., gaming console, tablet, mobile phone, etc.) to participate in the multi-player session. Other users who do not have the application installed on a selected device or when the selected device is not computationally powerful enough to executing the application may be participating in the multi-player session via a cloud based instance of the application executing at the cloud game network 190.

As shown, the cloud game network 190 includes a game server 160 that provides access to a plurality of video games. Applications played in a corresponding single player and/or multi-player session may be played over the network 150 with connection to the game server 160. For example, in a multi-player session involving multiple instances of an application (e.g., generating virtual environment, gaming world, metaverse, etc.), a dedicated server application (session manager) collects data from users and distributes it to other users so that all instances are updated as to objects, characters, etc. to allow for real-time interaction within the virtual environment of the multi-player session, wherein the users may be executing local instances or cloud based instances of the corresponding application. In particular, game server 160 may manage a virtual machine supporting a game processor that instantiates a cloud based instance of an application for a user. As such, a plurality of game processors of game server 160 associated with a plurality of virtual machines is configured to execute multiple instances of one or more applications associated with gameplays of a plurality of users. In that manner, back-end server support provides streaming of media (e.g., video, audio, etc.) of gameplays of a plurality of applications (e.g., video games, gaming applications, etc.) to a plurality of corresponding users. That is, game server 160 is configured to stream data (e.g., rendered images and/or frames of a corresponding gameplay) back to a corresponding client device 110 through network 150. As such, a computationally complex gaming application may be executing at the back-end server in response to controller inputs received and forwarded by client device 110. Each server is able to render images and/or frames that are then encoded (e.g., compressed) and streamed to the corresponding client device for display.

In single-player or multi-player sessions, instances of an application may be executing locally on a client device 110 or at the cloud game network 190. In either case, the application as game logic 115 is executed by a game engine 111 (e.g., game title processing engine). For purposes of clarity and brevity, the implementation of game logic 115 and game engine 111 is described within the context of the cloud game network 190. In particular, the application may be executed by a distributed game title processing engine (referenced herein as “game engine”). In particular, game server 160 and/or the game title processing engine 111 includes basic processor based functions for executing the application and services associated with the application. For example, processor based functions include 2D or 3D rendering, physics, physics simulation, scripting, audio, animation, graphics processing, lighting, shading, rasterization, ray tracing, shadowing, culling, transformation, artificial intelligence, etc. In that manner, the game engines implement game logic, perform game calculations, physics, geometry transformations, rendering, lighting, shading, audio, as well as additional in-game or game-related services. In addition, services for the application include memory management, multi-thread management, quality of service (QoS), bandwidth testing, social networking, management of social friends, communication with social networks of friends, social utilities, communication channels, audio communication, texting, messaging, instant messaging, chat support, game play replay functions, help functions, etc.

In one embodiment, the cloud game network 190 may support artificial intelligence (AI) based services including chatbot services (e.g., ChatGPT, etc.) that provide for one or more features, such as conversational communications, composition of written materiel, composition of music, answering questions, simulating a chat room, playing games, and others.

Users access the remote services with client devices 110, which include at least a CPU, a display and input/output (I/O). For example, users may access cloud game network 190 via communications network 150 using corresponding client devices 110 configured for providing input control, updating a session controller (e.g., delivering and/or receiving user game state data), receiving streaming media, etc. The client device 110 can be a personal computer (PC), a mobile phone, a personal digital assistant (PAD), handheld device, etc.

The client devices 110 may be operating using different platforms. For example, one or more client devices may be operating on a first platform (e.g., gaming consoles), and other client devices may be operating a different platform (mobile phones). In still another platform, a platform includes both a client device and game server 160 located at the cloud game network 190 in support of a cloud based instance of an application. As previously described, each platform may include a combination of hardware and software components providing a set of capabilities in order to execute one or more software applications (e.g., video games).

In particular, client device 110 of a corresponding user is configured for requesting access to applications over a communications network 150, such as the internet, and for rendering for display images generated by a video game executed by the game server 160, wherein encoded images are delivered (i.e., streamed) to the client device 110 for display. For example, the user may be interacting through client device 110 with an instance of an application executing on a game processor of game server 160 using input commands to drive a gameplay. Client device 110 may receive input from various types of input devices, such as game controllers, tablet computers, keyboards, touch screens, gestures captured by video cameras, mice, touch pads, audio input, etc.

As previously introduced, client device 110 may be configured with a game title processing engine 111 and game logic 115 (e.g., executable code) that is locally stored for at least some local processing of an application, and may be further utilized for receiving streaming content as generated by the application executing at a server, or for other content provided by back-end server support. In another implementation, client decide 110 acts as a stand-alone system for purposes of executing the application, such as when supporting a game play of a video game.

In another embodiment, client device 110 may be configured as a thin client providing interfacing with a back end server (e.g., game server 160 of cloud game network 190) configured for providing computational functionality (e.g., including game title processing engine 111 executing game logic 115—i.e., executable code—implementing a corresponding application).

In addition, system 100 includes a recap engine 120 configured to provide recap services using artificial intelligence that help the user recall mental and/or physical memories of their game play of a video game. In particular, the services include the generation of a video recap of key events in a game play of a video game. The video is generated incorporating scenes from the game play of the user, as well as developer created storyline cinematics, wherein the video may follow a storyline unique to the game play of the user, using artificial intelligence. Other services including a replay of scenes, or the replay of skills or moves (e.g., of a character) learned during the game play, wherein the replay is controllable by the user. Also, the replaying of scenes and/or moves is initiated and or instantiated from the actual game play of the user. In that manner, the user is able to mentally recall memories of the video game story arc or of their game play of the video game that were previously learned. Also, through replaying of moves and/or scenes, the user is able to physically recall how a move is initiated during their game play. As such, artificial intelligence is able to identify and/or classify key events during a game play of the video game by the user. For example, key events include important scenes within the game play, important story arc cinematics, and skills and/or moves learned during the game play. These key events are used to generate the video recapping those key events in the game play, and to enable replay of scenes encountered during the game play and skills and/or moves learned during the game play of the video game.

The recap engine 120 may be implemented at the back-end cloud game network, or as a middle layer third party service that is remote from the client device. In some implementations, the recap engine 120 may be located at a client device 110 and/or a secondary device 101, or a combination. That is, the recap engine 120 may be local to a user, such as operating within a client device 110 and/or a secondary device 101 of the user, or may be remote from the user and operate at a back-end server. For instance, the recap engine 120 may be operating in isolation in the client device 110, wherein the client device may provide interfacing with the user via user interface 400A. Also, the recap engine 120 may be operating in isolation in the secondary device 101 of the user, wherein the secondary device may provide interfacing with the user via user interface 400B. Further, the recap engine 120 may be operating cooperatively using both the client device 110 and the secondary device 101. For instance, the client device 110 (e.g., game console) may provide the processing for the recap engine 120, and the secondary device 101 (e.g., mobile phone) may provide interfacing with the user, such as via a user interface 400B. In another embodiment, the client device 110 and/or the secondary device 101 act as a front-end for recap engine 120 operating at the back-end of system 100 (i.e., at the cloud game network 190), wherein the front end provides for interfacing with the user, such as via a corresponding user interface 400A and 400B. In any implementation, the client device 110 and/or the secondary device 101 provide interfacing with the user, such as when requesting and/or receiving recap services provided by the recap engine.

The recap engine 120 is configured to classify and/or identify key events occurring within a game play of a video game by a user using artificial intelligence. Key events include important interactions with a gaming environment that progresses the game play (e.g., critical to the progression and/or completion of the story arc of the video game), or interactions with the gaming environment that are uniquely important to the user (e.g., finishing one or more side quests for a user that enjoys side quests) (e.g., based on a user profile). The interactions may be centered around a character that is controlled by the user. For example, key events may include earning an asset (e.g., weapon, treasure, etc.), passing a level, beating a boss, interactions with a non-player character (NPC), learning a new move, and any other important information that may be useful in helping the user to recall or remember their game play (e.g., what occurred, learned moves, important tasks, overall story arc of the video game, etc.). Artificial intelligence is used to analyze game state data of a plurality of game plays of the video game by a plurality of players, the game state data of the game play of the video game by a particular user, screen shots from the game play of the user and game plays of other players, and any other data useful in generating a video recap and other information that help the user recall their game play. Further, the artificial intelligence is used to generate services that help the user recall their game play, such as a video recap of key events in the game play of the user, and/or enabling a replay of key events (e.g., ability to replay a scene included in the video recap), and/or a tutorial to enable the user to remember a learned move occurring within the game play of the user. The classification and/or identification of key events, and the generation of a video recap and/or other services helping a user recall their game play may be performed using artificial intelligence (AI) via an AI layer. For example, the AI layer may be implemented via an AI model 170 as executed by a deep/machine learning engine 195 of the recap engine 120. It is understood that one or more AI models may be implemented, each of which being configured to perform customized classification and/or identification and/or generation of data (e.g., identify a key events in the game play of a user, identify other information helpful for a user to recall their game play, and generate services to help the user recall their game play (e.g., video recap, replay a scene, tutorial to relearn moves, etc.).

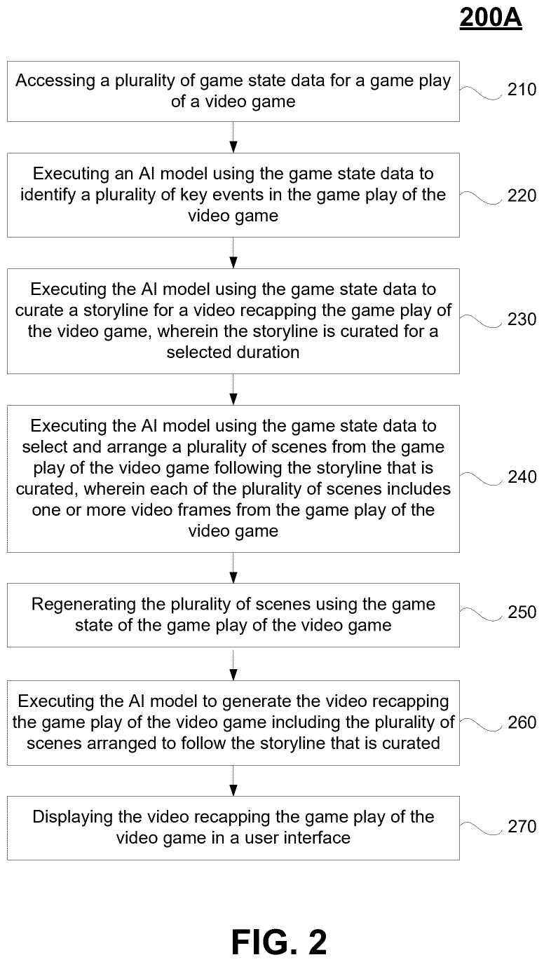

With the detailed description of the system 100 of FIG. 1, flow diagram 200 of FIG. 2 discloses a method of generating, using artificial intelligence, a video recapping a game play of a video game by a user, and incorporating scenes from key events in that game play, in accordance with one embodiment of the present disclosure. In that manner, a user is reminded on what occurred during their game play of a video game, and how to play the video game, such as by replaying selected scenes and engaging with tutorials that provide for replaying scenes where the user unlocked moves. For example, after a prolonged period of inactivity in playing the game, the user can be reminded about their game play by viewing the video recapping key events, as well as accessing other services related to the video (i.e., provided by the recap engine). The operations performed in the flow diagram may be implemented by one or more of the previously described components of system 100 described in FIG. 1, including the recap engine 120.

Further, the operations of flow diagram 200 may be implemented to provide additional services configured to help the user remember the video game, to remember the story arc, to remember their game play of the video game, and how to play the video game, using artificial intelligence that relies on and/or incorporates elements of the game play of the user. For example, one of these services includes displaying the video recapping key events in the game play of the user. These services can be accessed through a user interface.

In embodiments, the user interface providing recap engine services is actively triggered, or may be passively triggered. For example, the user may actively (e.g., manually) request the user interface in order to access recap engine services, such as a video recapping key events in the game play of the user. In embodiments, a selection button or icon is present and overlaid a scene in the game play of the video. The selection button may always be present in one embodiment, or appear when the system detects that the user would benefit from one or more services provided by the recap engine. For example, the selection button may appear for a period of time, allowing the user the opportunity to access these services. The selection button may linger or disappear depending on how long a time has passed where the button is not selected by the user, and/or how well the user is performing in the game play. For instance, if the user continues to struggle, then the selection button may linger for a longer period of time, or on the other hand, if the game play is more successful, then the selection button may start to fade or completely disappear.

In one embodiment, the user interface is passively triggered by the system implementing the recap engine through detection that the user is struggling through their game play (e.g., having difficulty completing a task, repetitively looping through the same fruitless actions, having difficulty passing a level, trapped in a scene, etc. In one embodiment, the user interface providing recap engine services is triggered and provided to the user when the user has not played their game play of a video game after a threshold period of time (e.g., more than 6 months, etc.). In another embodiment, the user interface providing recap engine services is triggered and provided to the user when the system detects that the user has played one or more separate video games in the interim period after the last time the user has played their game play of the video game. That is, the user has hopped between stories in-game plays of different video games, and may have trouble remembering the storyline or story arc of the video game of interest, or even how to play the video game. For example, the user may be unsuccessfully implementing moves for the game play of a first video game, but the moves are designed for a second video game. In still another embodiment, the system detects that the user is not using the full complement of moves that have been unlocked in their game play of the video game, and the user interface is triggered to provide the user a tutorial on how to execute those unlocked moves. In still another embodiment, the user interface is triggered based on a threshold period of time passing since the last time the user played the video game (e.g., 3 months, etc.).

Detection of one or more characteristics of the game play of the video game as controlled by the user may be performed through analysis of one or more items of data, depending on how much time is available for processing. For instance, items of data may include game state data of the game play, and screen shots of video frames of the game play. Because game state data is compute intensive, real-time analysis of the data may not be possible. On the other hand, when real-time analysis is required, screen shots of the game play may be selected for processing over other data (e.g., game state data) requiring cumbersome processing.

At 210, the method includes accessing a plurality of game state data for a game play of a video game controlled by a user. Captured game state data allows for the generation of the gaming environment at the corresponding point in the game play. Additional information may be collected useful, such as user saved data that personalizes the video game for the corresponding player. Other information may be collected, such as screen shots of the game play (e.g., the video frames). For example, screen shot data may be utilized when it is more suitable for processing, or when game state data is unavailable, or when game state data is too cumbersome to process. Game state data corresponding to game plays of the video game by other players may also be collected. This data may be related to, complementary, and/or supportive of the game state data captured for the game play of the user of the video game.

In particular, game state capture may require cooperation with a developer of the video game to allow for access to the game state on developer servers (e.g., active access of game state in databases of the developer), or constantly receiving streaming of the game state from the developer. The game state is associated with all the game plays of all the developer's video games, and includes massive amounts of data that may or may not be relevant to the current game play of a video game by a user. The game state data may need to be reformatted for use by downstream components. As such, preliminary processing of game state includes parsing the game state data to find data relevant to the game play of the user, and further translating the data to a useable format for processing. As previously introduced, processing of game state data may not be suitable for real-time analysis, as the amount of data is extensive. However, for purposes of embodiments of the present disclosure, various uses of the game state data do not require real-time analysis of data and can be used to provide recap engine services.

At 220, the method includes executing an artificial intelligence (AI) model using the game state data to identify a plurality of key events in the game play of the video game. In one implementation, the AI model is trained using game state data and/or other information (e.g., screen shots of the game plays) captured from game plays of one or more players playing the video game, and possibly other video games, wherein the training includes identifying key events during game plays of a particular video game and/or a plurality of video games. Training is possible using game plays from one or more video games to help identify key events that are generic to all game plays. Training using data from game plays of the instant video game may be necessary to help identify key events that are specific to that particular video game.

In particular, the AI model is trained to classify and/or identify a plurality of key events occurring within a game play of a particular video game, as controlled by a user. As previously introduced, key events include important interactions with a gaming environment of the video game during the game play. For instance, game oriented key events may be critical to or fulfill the story arc of the video game, and/or are significant to the game play (e.g., necessary to progress the game play). Other key events may be important to the experience of the user while playing the video game, and are personal or local or specific to the game play by the user. For illustration purposes, more personal key events include, in part, areas or regions visited within the gaming environment, quests started, quests completed, achievements, tasks started, tasks completed, assets earned (e.g., weapons, treasure, etc.), moves unlocked, first time a move is unlocked and within what scene, bosses engaged with, bosses beaten, levels reached, levels completed, interactions with NPCs, relative score against a common enemy in the video game compared to scores from other players (including a highest score of the user compared to all scores from other players, relative time of the user to beat a common enemy compared to times from other players (including fastest time of the user compared to all times of other players), and other important information that may be enjoyable to the user. In some cases, a user profile may help define these personalized or localized key events, such as when a user is categorized as a type of player (e.g., completionist that completes every side quest, casual player, hardcore gamer that desires to finish a game as quickly as possible, etc.). For example, when the user is classified as a completionist, then key events may include more side quests than for another player, because side quests are important to the user. other key events may be global to all players playing the video game (e.g., weapon achieved, boss beaten, etc.). In that manner, the AI model is able to classify and/or identify the key events occurring within a game play of a video game as controlled by the user.

In one embodiment, the AI model is reinforced and/or validated during training using game state captured from a plurality of game plays of the video game by a plurality of users, and/or the game play of the specific user utilizing recap engine services. Since there is no pressure to provide real-time analysis, capturing and analyzing game state is possible in order to classify and/or identify and/or reinforce/verify the plurality of key events.

In one embodiment, after the key events within the game play by the user are identified and/or classified, those key events are tagged. For example, tagging of key events may occur continuously as the user is playing the video game. That is, the identification and/or classification, and further tagging of key events occurs within the background of the game play of the user. In that manner, these tagged events can be used to provide real-time services to the user at a later time, such as when picking up playing a video game after a prolonged period of inactivity.

At 230, the method includes executing the AI model using the game state data and/or screen shot data to curate a storyline for a video recapping the game play of the video game. The storyline that is curated is based on the key events, previously identified using artificial intelligence. For example, the storyline may summarize the general story arc of the video game. Spoilage of the game for the user is not anticipated, as the general story arc provides a backdrop to the video game that is generic, and assumed to be previously known to all potential players. In another example, the storyline may also summarize the personal story arc created during the game play of the user, which is personalized to the game play of the user. Again, spoilage of the game is not possible following the personal story arc, as the storyline is curated up to the point of the current context of the game play. That is, no spoiler alerts are necessary. As such, the storyline that is curated may include the general story arc of the video game, and/or the personal story arc created during the game play of the user, and/or a combination of the two types including selected portions of each to curate the storyline.

In addition, the storyline is curated for a selected duration, wherein the duration may be selected by the user. For example, the user may request a video recapping key events of a short, medium, or long duration, depending on how much available time the user has, and/or the complexity of the video as desired by user. That is, a less complex video requires less time, and as such, the storyline that is curated may be more simplistic and including fewer key events to support the storyline. On the other hand, a more complex video requires more time, and includes many key events that can support a fuller storyline.

Furthermore, the storyline may be based on how long is the interim period since the last time the user played the video game. A duration of the video recapping key events may be adjusted based on the length of the interim period, such as adjusting the duration of the video selected by the user based on the length of the interim period. For example, when the interim period is of a shorter duration (e.g., less than three months, etc.), the user probably remembers most of the overall story arc of the video game, and most of the story arc of their game play, and just needs a short refresher on what is going on in their game play, and possibly the more important unlocked moves. As such, the video recapping key events may be short (e.g., less than 5 minutes). On the other hand, when the interim period of a longer duration (e.g., more than 6 months or more than 12 months, etc.), the user may have forgotten most of the details about the video game (i.e., the generic story arc, and personalized story arc of their game play). For instance, the user may have played other games in the interim period, and has forgotten all of the moves pertinent to this video game, and may have even forgotten what task is currently being undertaken, and may have forgotten what the overall goal is when playing the video game. In that case, the video recapping key events may be longer (e.g., more than 15 or 30 or 60 minutes, etc.).

As previously introduced, the storyline may be curated up to a current point in the game play of the user, based on a current context of the game play. This guarantees that no spoilage of the video game for the user will occur, and as such no spoiler alerts need to be generated and displayed. In one implementation, the current context of the game play is determined by the AI model, for use in curating the storyline. Game state data may be analyzed by the AI model to determine the current context. In another implementation, screen shots from the game play of the video game may be analyzed by the AI model to determine the current context. In either implementation, real-time analysis may be performed to determine the current context. For example, when using game state data, the last played current context of the game play is determined by the AI model at the time the video game was last played by the user, and stored. In that manner, when the user picks up the game at a later time, the current context is known and useable for performing recap engine services. In another example, when using screen shots, the user may be actively participating in the game play. In that case, game state data may be too cumbersome for real-time analysis, and so screen shots may be analyzed in real-time to determine a current context of the game play. More particularly, the AI model is trained using game state data and/or a plurality of screen shots (e.g., video frames, etc.) that are captured. Specifically, the AI model is trained to identify a plurality of contexts of a plurality of points in any game play of the video game. As such, the AI model is configured to classify and/or identify a context of a current point in the game play of the video game by the user.

At 240, the method includes executing the AI model using the game state data to select and arrange a plurality of scenes from the game play of the video game following the storyline that is curated, wherein the storyline is based on one or more key events that are identified using the AI model. More particularly, each of the plurality of scenes includes one or more video frames from the game play of the video game, and wherein the scenes include and/or correspond to the one or more key events that are identified for the game play of the user. In addition, spoilage is minimized because the video is created using scenes from the game play of the user. In that manner, the scenes as selected and arranged to follow the storyline of the video summarizes key events in the game play of the user.

At 250, the method includes regenerating the plurality of scenes using the game state of the game play of the video game. In particular, the game state corresponding to each of the plurality of scenes is identified, wherein the game state is captured from the game play of the user. In one implementation, the AI model is trained to identify the game state corresponding to each of the plurality of scenes. In another implementation, analysis of the game state data is performed to identify to which scene does a segment of the game state data correspond. That is, as game state is collected, analysis is performed to relate pieces of game state data to video frames and/or scenes of a corresponding game play.

At 260, the method includes executing the AI model to generate the video recapping the game play of the video game. The video includes the plurality of scenes arranged to follow the storyline that is curated. More particularly, the video includes one or more video frames, regenerated from the game play of the user, corresponding to each of the plurality of scenes.

In one embodiment, one or more filler scenes are interleaved with the plurality of scenes, from the game play of the user, selected and arranged to follow the storyline that is curated. For example, a filler scene may help to transition between two adjacent scenes, from the game play of the user, that are used in the video. That is, a filler scene helps to complete the storyline that is curated. As such, the video recapping the game play of the video game includes the plurality of scenes from the game play of the user, and one or more filler scenes.

A filler scene may be taken from a plurality of filler scenes generated from a plurality of game plays of the video game, as controlled by a plurality of players. These filler scenes may be generic and applicable to all game plays. For example, a filler scene may be a backdrop of the gaming environment. In another example, a filler scene may be common between two points in all of the game plays of the video game, such as having the character traverse an area (e.g., walk through a forest, climb a cliff, etc.) between two regions of the gaming environment. In one embodiment, An AI model may be trained to identify filler scenes applicable to the video game. One or more filler scenes may be stored in an index 366.

At 270, the method includes displaying the video recapping the game play of the video game in a user interface. The user interface may be presented via a display on a device of the user. For example, the device may be a game console providing recap engine services, to include a display showing the user interface. In another example, the device may be a secondary device (e.g., mobile phone), having a display for showing the user interface. As previously described, the device may be a front-end for the user to access recap engine services.

In another embodiment, an audio track is created and/or curated, using an AI model, to follow the plurality of scenes in the video recapping key events in the game play of the user. The audio track is consistent with a musical theme used for the video game. In particular, an AI model is trained to capture a plurality of audio segments that are broadcast during a plurality of game plays of the video game by a plurality of users, and not specifically captured during the game play of the user. That is, an audio segment may be universal to all game plays. The audio segments may be stored in an index 367. For example, the audio segments may correspond to key audio moments (crescendo, peaceful, staccato, etc.) occurring during the game plays. For example, an audio segment may provide a backdrop to general portions of the game play (e.g., peaceful music), or an audio segment that is rising in crescendo in alignment with a battle with a boss reaching its conclusion, or an audio segment that is in staccato occurring with a battle scene, or any other type of audio segment. As such, the audio track is curated to include one or more audio segments, wherein the audio segments are selected and arranged to follow the storyline that is curated. Further, the AI model is configured to stitch together the audio segments in order to create the audio track.

Also, the audio track that is curated is added to (e.g., overlaid) the video recapping the game play of the video game. The audio segments arranged in the audio track is in alignment with the plurality of scenes that correspond with key events in the game play of the user. Further, the scenes and the audio segments follow the storyline that is curated for the video recapping key events (e.g., from one key event to another). In that manner, the user becomes more fully immersed in their own game play (i.e., using visual and auditory senses), as the video recapping key events in the game play of the user also properly reflects the music of the video game. That is, the video recapping key events also provides an accurate auditory feel for the video game (e.g., for any player playing the video game). Moreover, the audio track that is curated properly reflects the emotions generated during the game play of the video game.

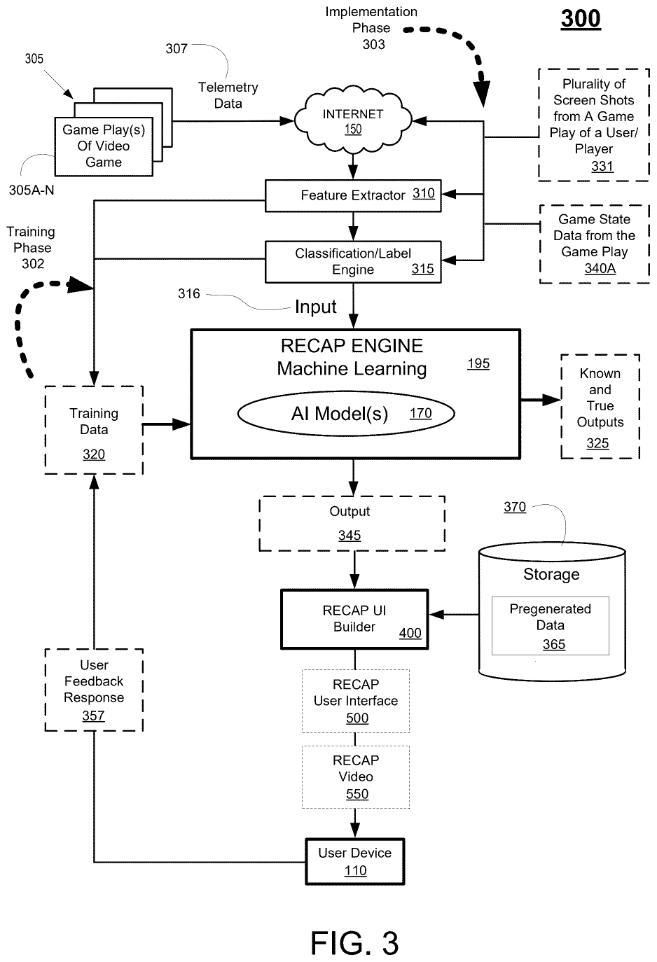

FIG. 3 is an illustration of a system 300 configured to implement an AI model configured for extracting and classifying key events occurring in, and relevant information related to, a game play of a video game by a user, wherein the system is configured to generate a video recapping the game play that incorporates scenes from the game play of the user that correspond to the key events, in accordance with one embodiment of the present disclosure. For purposes of illustration, the system of FIG. 3 may be implemented by the cloud game network 190, or the client device 110, or secondary device 101 of FIG. 1, or a combination thereof. Further, the system may be implemented through a third party or mid-level recap engine communicatively coupled through a network.

The system may be implemented during game play of a video game to help the user recall details about the video game itself, and details about their game play of the video game. In addition, the system may be implemented during one or more game plays of the video game by one or more players to train the AI model 170, which may include one or more sub-level or compartmentalized AI models. As such, FIG. 3 is an illustration of a training phase and an implementation phase of AI model 170 that is configured, in part, to identify and/or classify a key events occurring within a game play of a video game of a user, and otherwise identify other relevant information useful for helping the user recall their game play of the video game.

In particular, key events of a game play of a video game by a user may be identified and/or classified and/or generated using the AI model 170, also referred to as an AI learning model. Also, the AI model 170 is configured to curate a storyline for a video recapping the key events, to further select and arrange scenes from the game play of the user following the storyline that is curated, regenerate the scenes using corresponding game state data, and generate a video recapping the key events in the game play of the user. Further, the AI model may be configured to identify key audio moments occurring during game plays of the video game by one or more players, and create audio segments corresponding to those audio moments, and curate an audio track following the scenes in the storyline for use in the video.

The AI model 170 is updateable by providing feedback and/or trusted data to continually train the AI model. In one embodiment, the AI learning model is a machine learning model configured to apply machine learning to classify levels of immersion in a game play of a specific player. In another embodiment, the AI learning model is a deep learning model configured to apply deep learning to classify levels of immersion of the player during game play, wherein machine learning is a sub-class of artificial intelligence, and deep learning is a sub-class of machine learning. As such, artificial intelligence is used to identify, classify, and/or generate queries, information related to the queries, and responses to those queries during game play of a video game by a user.

As shown, the AI model 170 may be configured for a training phase 302 (e.g., horizontal direction through the AI model 170) to learn one or more relevant items of data useful in identifying and/or classifying key events when playing a video game, for curating a storyline recapping key events, selecting scenes from the game plays suitable for the storyline, identifying game state used for regenerating those scenes, curating an audio track in alignment with the scenes, and generate a video recapping those key events using the selected scenes. For example, game plays of the video game by multiple players can be monitored and provided as input to the AI model 170 for learning. In some cases, the game play of the user is provided as input to the AI model for learning.

Also, the AI model 170 may be configured for an implementation phase 303 (e.g., vertical direction through the AI model) for purposes of identifying and/or classifying key events occurring within a game play of a user, and for curating a storyline for a video recapping those key events, selecting and arranging scenes from the game play of the user that follow the storying that is curated, regenerating those scenes using game state from the game play of the user, curating an audio track in alignment with the scenes that are arranged following the storyline, and generate a video recapping those key events using scenes from the game play of the user. Because the implementation phase relies on continued analysis of game state data from the game play of the user, the generation of a video recapping the key events in the game play of the user, and generation of additional data used for other recap engine services, can be performed in real-time, such as while the user is playing the video game. In that manner, the user is able to utilize the recap engine services to recall details related to their game play of the video game.

During the training phase 302, telemetry data 307 is collected from a plurality of game plays 305, including game plays 350A-N and/or screen shots or video frames of the game plays, of one or more players playing a video game. The telemetry data may be collected through a communication network 150, or directly delivered. Telemetry data may include game state data, video frames, screen shots, user saved data, and metadata. Specifically, game state data defines the state of the game play of an executing video game for a player at a particular point in time. Game state data allows for the generation of the gaming environment at the corresponding point in the game play. For example, game state data may include states of devices used for rendering the game play (e.g., states of the CPU, GPU, memory, register values, etc.), identification of the executable code to execute the video game at that point, game characters, game objects, object and/or game attributes, graphic overlays, and other information. User saved data includes information that personalizes the video game for the corresponding player. For example, user saved data may include character information and/or attributes that are personalized to a player (e.g., location, shape, look, clothing, weaponry, assets, etc.) in order to generate a character and character state that is unique to the player for the point in the game play, game attributes for the player (e.g., game difficulty selected, player customized game settings, game level, character attributes, character location, number of lives, trophies, achievements, rewards, etc.), user profile data, and other information. Metadata is configured to provide relational information and/or context for other information, such as the game state data and the user saved data. For example, metadata may include information describing the gaming context of a particular point in the game play of a player, such as where in the game the player is, type of game, mood of the game, rating of game (e.g., maturity level), the number of other players there are in the gaming environment, game dimension displayed, the time of the collection of information, the types of information collected, region or location of the internet connection, which players are playing a particular gaming session, descriptive information, game title, game title version, franchise, format of game title distribution, network connectivity, downloadable content accessed, links, language, system requirements, hardware, credits, achievements, awards, trophies, and other information.

The telemetry is delivered to the feature extractor 310 that is configured to extract out the salient and/or relevant features from the telemetry data 307 that is useful in providing services that help the user recall information about the video game in general, and/or information about their game play of the video game. For example, the feature extractor may be configured to define features that are associated with information useful in identifying key events, storyline curating, scene selection for a corresponding storyline, identification of game state data corresponding to scenes in-game plays, scene regeneration, audio moment identification and audio track generation, and video generation recapping corresponding key events selected for a corresponding storyline, and other relevant information. In some implementations, both feature definition and extraction is performed by the AI model 170, such that feature learning and extraction is performed internally within the AI model. In addition, extracted features are classified or labeled by classification/label engine 315. In that manner, the extracted features can be classified and/or labeled (e.g., as information related to key events, information related to audio segments and audio track generation, information related to storyline curation, information related to scene selection following a storyline, information related to video generation, information related to game context identification, etc.). In another embodiment, the extraction and/or classification of features may be performed by the deep/machine learning engine 195. Data obtained from the feature extractor 310 and/or the classification/label engine 315 may be collected as training data 320 for submission to the recap engine machine learning engine 195 for training the AI model 170.

As shown, the deep/machine learning engine 195 is configured for implementation of AI model 170 for training and/or implementation based on an input set of data (e.g., extracted features that may be further classified and/or labeled. In one embodiment, the AI model 170 is a machine learning model configured to apply machine learning to identify/learn/classify key events when playing a video game, curating a storyline recapping key events, selecting scenes from game plays for the storyline and their corresponding game state, generating the scenes using corresponding game state data, curating an audio track, and generating a video recapping key events using selected scenes and a curated audio track, as well as other services provided by the recap engine. In another embodiment, the AI learning model is a deep learning model configured to apply deep learning to perform the same operations, wherein machine learning is a sub-class of artificial intelligence, and deep learning is a sub-class of machine learning.

Purely for illustration, the deep/machine learning engine 195 may be configured as a neural network used to train and/or implement the AI model 170, in accordance with one embodiment of the disclosure. Generally, the neural network represents a network of interconnected nodes responding to input (e.g., extracted features) and generating an output related generally to the video game and for services helpful in recalling details of the video game and/or a particular game play of the video game.

[symbol] (e.g., key events, audio segments, curated storyline, scene selection and regeneration using corresponding game state data that is identified, audio track generation, and video generation, etc.). That is the AI model 170 is trained to learn one or more aspects of a video game, such that at a current point in a game play of a video game by a user the AI model is able to identify and/or classify key events in the game play, audio segments, generate a curated storyline, provide for scene selection and regeneration using corresponding game state data that is identified, audio track generation, and video generation summarizing the key events, etc. Generally, the neural network in the machine learning engine 190 represents a network of interconnected nodes, such as an artificial neural network, and is used to train the AI model 170. In one implementation, the AI neural network includes a hierarchy of nodes. For example, there may be an input layer of nodes, an output layer of nodes, and intermediate or hidden layers of nodes. Input nodes are interconnected to hidden nodes in the hidden layers, and hidden nodes are interconnected to output nodes. Each node learns some information from data. Knowledge can be exchanged between the nodes through the interconnections. Interconnections between nodes may have numerical weights that may be used link multiple nodes together between an input and output, such as when defining rules of the AI model 170. Input to the neural network activates a set of nodes. In turn, this set of nodes activates other nodes, thereby propagating knowledge about the input. This activation process is repeated across other nodes until an output is provided

During the training phase 302, training data 320 (e.g., extracted features and/or classified features) may be provided as input to the recap engine machine learning system 195, which implements a training algorithm to fit the structure of the AI model 170 to the training data by tweaking the parameters of the AI model, so that the trained AI model provides an accurate relationship between input (training data) and output. As such, the training data 320 is fed to the machine learning engine 195, which utilizes artificial intelligence, including supervised learning algorithms, unsupervised learning algorithms, reinforcement learning, or other artificial intelligence-based algorithms to build the AI model 170. In particular, training and/or learning may be supervised using known and true outputs 325 (e.g., key events, scenes, game state corresponding to scenes, etc.) associated with the training data 320. Training and/or learning may be unsupervised, wherein no known or true outputs are provided for the training data 320, such that input data is only provided and the AI model 170 learns to determine key events in the game play, audio segments, generate a curated storyline, provide for scene selection and regeneration using corresponding game state data that is identified, audio track generation, and video generation summarizing the key events, etc. Also, training may implement both supervised and unsupervised training. For example, after performing unsupervised training, supervised learning may be performed with known data.

In particular, the AI model 170 is configured to apply rules defining relationships between features and outputs (e.g., key events, curated storyline, scene selection and regeneration, video generation, etc.), wherein features may be defined within one or more nodes that are located at one or more hierarchical levels of the AI model 170. The rules link features (as defined by the nodes) between the layers of the hierarchy, such that a given input set of data leads to a particular output (e.g., a key event during game play of a video game) of the AI model 170. For example, a rule may link (e.g., using relationship parameters including weights) one or more features or nodes throughout the AI model 170 (e.g., in the hierarchical levels) between an input and an output, such that one or more features make a rule that is learned through training of the AI model 170. That is, each feature may be linked with one or more features at other layers, wherein one or more relationship parameters (e.g., weights) define interconnections between features at other layers of the AI model 170. As such, each rule or set of rules corresponds to a classified output.

As such, the neural network in the machine learning engine 195 configured to build the AI model 170 may identify and/or classify and/or generate one or more items of data related to a video game. For example, the AI model is configured to identify and/or classify and/or generate one or more of the following in relation to a video game: key events when playing a video game, a curated storyline recapping key events, game context identification, scene selection suitable for a corresponding storyline, regeneration of scenes using identified game state data, audio moment segment identification, audio track curation, video generation summarizing key events using scenes from a corresponding game play of the video game, and other data useful in helping a user recall details of a video game and/or their game play of the video game. As such, the resulting output 345 according to the rules of the AI model 135 that is now trained, may include data used by a recap user interface builder 400 for services provided by the recap engine, including a recap user interface 500, recap video 550, etc. suitable for use during implementation of the AI model 170.

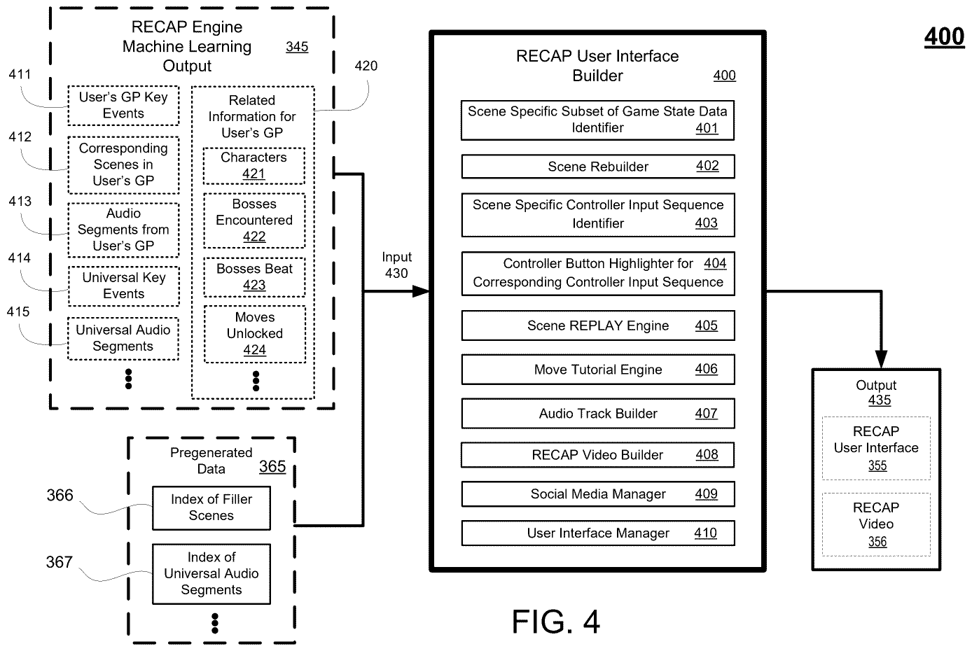

In particular, during the implementation phase 303 data is captured for input into the recap engine machine learning engine 195. For example, game state data 340A from a game play of a video game by a user is provided as input 316. Also, a plurality of screen shots 331 and/or video frames from the game play may also be provided as input 316. The game state data and/or screen shots may be provided to the feature extractor 310 to identify salient and relevant information related to key event identification, game context identification, and other data relevant for providing recap engine services. Further, the extracted features may be classified and/or labeled by the classification/label engine 315 prior to submission to the AI model 170. In some implementations, feature extraction and/or classification are performed by the AI model. In particular, for a given set of extracted features that are classified and provided as input 316 to the AI model 170, data relevant for providing recap engine services is provided as output 345 and is generated according to the rules of the AI model 170. For example, the AI model 170 is configured at least to identify and/or classify and/or generate one or more of the following in relation to a video game: key events occurring during the game play of the video game by the user, a curated storyline recapping those identified key events, game context identification for a current point in the game play by the user, selection of scenes from the game play following the storyline, identification of game state data for the selected scenes, regeneration of the selected scenes using corresponding game state data, audio track curation in alignment with the scenes and/or storyline, video generation summarizing the identified key events using scenes from the game play of the user, and other data useful in helping a user recall details of a video game and/or their game play of the video game. As such, the resulting output 345 may include data used by the recap user interface builder 400 in order to provide recap engine services. Additional pregenerated data 365 accessed through storage 370 may also be used by the recap user interface builder 400. More details of the features provided by the recap user interface builder 400 is provided in FIG. 4. For example, the recap UI builder 400 is configured to generate one or more variations of a recap user interface 500, a recap video 550 summarizing key event identified in a game play by the user, etc. The one or more service features output by the recap UI builder 400 may be delivered to a device 110, and/or secondary device 101, for access by the user, or any other viewer.

In addition, the user may provide feedback response 357 during the game play as to the value of the output provided by the AI model 170. For example, the feedback may be in the form of a tag that indicates whether the user liked or disliked the output by the AI model. For illustration purposes only, feedback may be provided indicating that the response for a predicted information (e.g., key event, scene selection, move identification, audio track generation, video, etc.) for a game play is valuable or not valuable, or have some middle valuation. The information provided as feedback may be newly included within the training data 120, and provided as input into the machine learning engine 195 for purposes of updating the AI model 170. Because the information is verified (e.g., by the player), the machine learning engine could apply a supervised learning algorithm by assigning the verified output as being a true output 125 when updating the AI model, in one embodiment.

FIG. 4 is a block diagram illustrating a recap user interface builder 400 configured to generate a video recapping game play of a user playing a video game, in accordance with one embodiment of the present disclosure. The recap user interface builder 400 is also configured to generate a user interface used for viewing the video recap, and is further configured provide additional services and/or features related to the video recap, in accordance with one embodiment of the present disclosure. one or more of the operations performed by the recap user interface builder 400 may be performed using artificial intelligence.

In particular, input 430 to the recap user interface builder 400 includes data from output 345 of the AI model 170, and/or pregenerated data 365, wherein the pregenerated data may include one or more filler scenes from index 366, and/or one or more universal audio segments in index 367. More particularly, the output 345 from the recap engine machine learning and/or AI model 170 may include data used by the recap user interface builder 400 to provide recap engine services. The output data 345 may include, in part, key events 411 from a game play of a user; corresponding scenes 412 from the game play that may be selected for a storyline; audio segments 413 from the game play of the user; key events 414 that may be universal to all game plays of the video game; audio segments 415 that are universal to all game plays of the video game; etc. The output data may include related information 420 relevant to the game play by the user. For example, related information 420 may include, in part, characters 421 played by and/or encountered by the user; bosses 422 that are encountered; bosses 423 that have been beaten; moves 424 that have been unlocked; etc.

The recap engine user interface builder 400 includes one or more components generating data that provide recap engine services, including the scene specific game state identifier 401, the scene rebuilder 402, the scene specific controller input sequence identifier 403, the controller button highlighter 404, the scene replay engine 405, the move tutorial engine 406, the audio track builder 407, the recap video builder 408, the social media manager, and the user interface manager 410.

In particular, once the scenes are selected that follow a storyline that is curated by the AI model, the game state data identifier 401 identifies the subset of game state that corresponds with those selected scenes. The functions of the game state data identifier can also be performed using artificial intelligence, such as by the AI model used for identifying key events that form the basis of the video recap.

The scene rebuilder 402 is configured to rebuild the selected scenes corresponding with identified key events during the game play of a user. That is, the selected scenes occur in the game play, and are rebuilt using corresponding subsets of game state data. In particular, an instance of the video game is instantiated using appropriate game state data to replicate the gaming environment for each of the scenes. Further, corresponding game state data is used to replay the game play for each scene. For example, controller inputs in the game state data are used to replicate the game play and generate the scene, such as the one or more video frames of the scene. In one implementation, the instance of the video game currently executing for the game play of the user is utilized to rebuild selected scenes, such as in the background of the currently executing game play.

The controller input sequence identifier 403 is configured to identify controller inputs used for generating each of the selected scenes in the game play of the user. In one embodiment, a representation of the controller inputs is shown along with a corresponding scene used in a video recapping key events in the game play of the user. Also, the controller button highlighter 404 may be used in conjunction with the controller input sequence identifier 403. For example, as the scene is being played in the video recapping the key events, a representation of a controller is shown, and buttons corresponding to activation of each of the controller inputs used during the scene are highlighted in alignment with video frames of the scene. In that manner, the user is able to follow the controller inputs previously used in the game play to generate the scene being shown in the video recapping key events.

A scene replay engine 405 is configured to jump the user into a scene using corresponding game state data. That is, an instance of the video game is instantiated using appropriate game state data corresponding with the scene to replicate the gaming environment at the beginning of the scene. In that manner, the user is able to actively control a replay the scene using newly activated controller inputs. The replay can be controlled at any point during the scene. For instance, the user may choose to have the scene play out using the previously entered controller inputs, and at a selected point, jump in to control the game play of the scene with new controller inputs. As previously introduced, the instance of the video game may be newly instantiated, or may be one that is currently executing for the game play of the user.

A move tutorial engine 406 is configured to provide an interface providing a tutorial on how to execute a move, such as when implementing a sequence of controller inputs for the move. The tutorial may include a textual representation of the move, such as providing a written description of the sequence of controller inputs. The tutorial may include a visual representation of the move, such as a bar that shows timing of the sequence of controller inputs, and magnitude and/or intensity for activating each of the controller inputs. Also, a representation of a controller may be shown, with each of the buttons highlighted during the sequence of controller inputs, as previously described. Further, the move tutorial engine 406 may include a replay feature that is controlled by the user. In particular, an instance of the video game is instantiated using appropriate game state data corresponding with a scene within which the move was utilized during previous game play of the user, such as near a point in the game play where the move was executed (and possibly successfully executed). The replay feature may overlay a ghost character showing successful completion of the move. The replay feature may overlay a representation of the previously executed controller input sequence with timing to show how to successfully perform the move, while the user is currently executing the move.

The audio track builder 407 is configured to build an audio track using audio segments previously identified for the video game. As previously described, the audio track follows the storyline that is curated, and is consistent with one or more musical themes generated for the video game. That is, not only does the audio track musically follow and support the scenes shown in the video recapping key events, but is generated using music from the video game to give the user a real feel for playing the video game.

The recap video builder 408 is configured to generate a video recapping the identified key events of the game play of the user, using scenes from the game play of the user corresponding to those key events. As previously described, the scenes are regenerated using corresponding game state data. Filler scenes may be also be presented within the video to transition between selected scenes.

A social media manager 409 is configured to manage and/or monitor social media surrounding the game play of the user. For example, the user may participate in a side chat while playing a video game in single-player or multi-player mode. The side chat may be monitored to determine context of the conversation, and participants in the conversation. Relevant social media information may be presented in the user interface providing recap engine services, such as the video recapping key events from the game play of the user.

The user interface manager 410 is configured to determine which form of the user interface is presented to the user, including determining which features to include in the user interface (e.g., recap user interface 355), such as those selected by the user. Further, the UI user interface manager is configured to monitor and/or respond to interaction by the user in order to launch selected features for inclusion within the user interface, such as within one or more windows.

As such, the recap engine user interface builder 400 provides as an output 435 a recap user interface 355 including one or more features of the recap engine. In particular, one or more windows or sandboxes may be implemented within the recap user interface 355, each supporting a different feature and/or service provided by the recap engine, such as the recap video 356 summarizing key events within the game play of the user. For example, each feature and/or service may be supported by a corresponding user interface within the corresponding window. The user interface 355 may be configured to show a selected feature in isolation, such as the video recapping key events, or a replay of a corresponding scene or move, as controlled by the user.

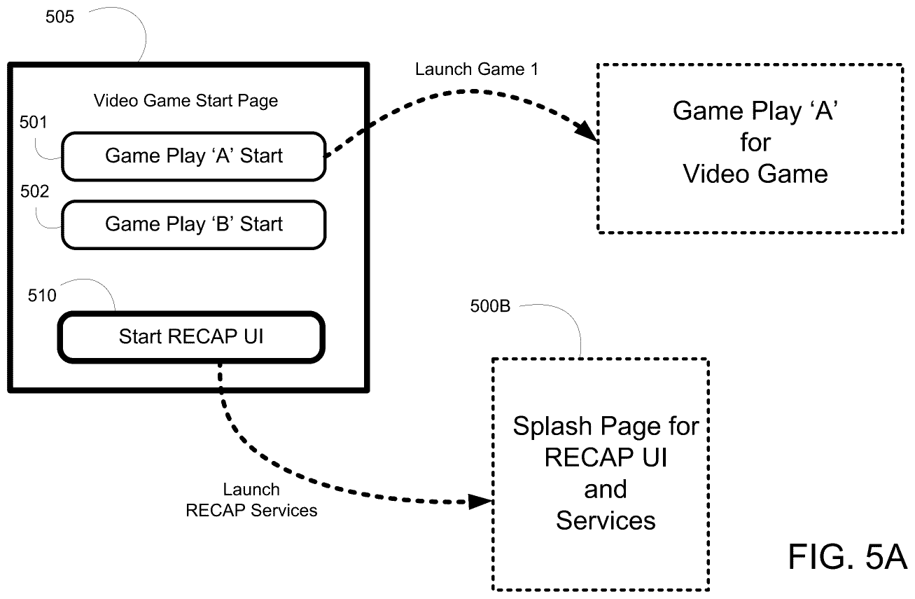

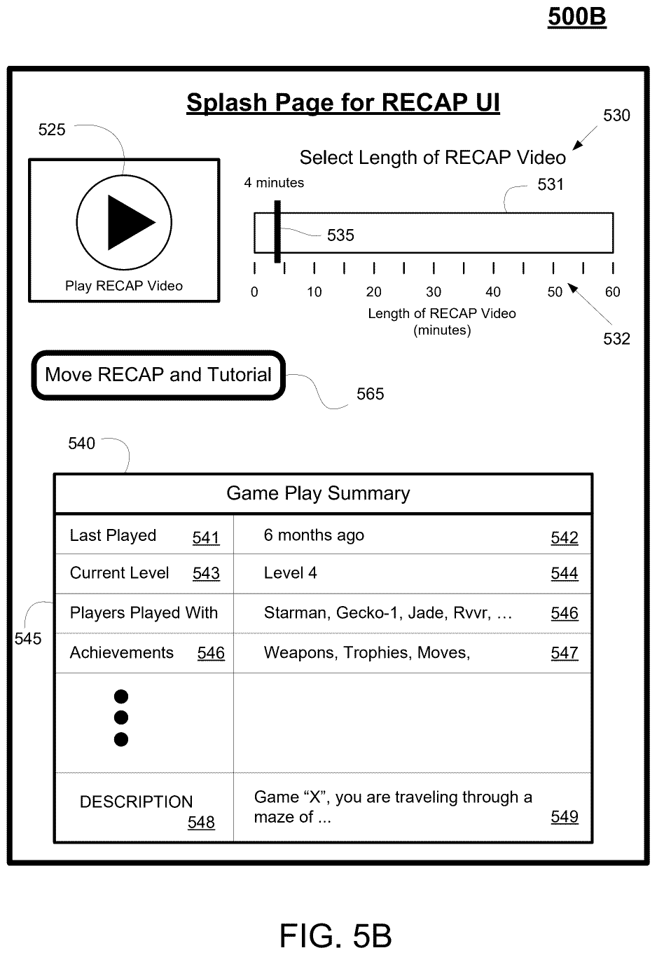

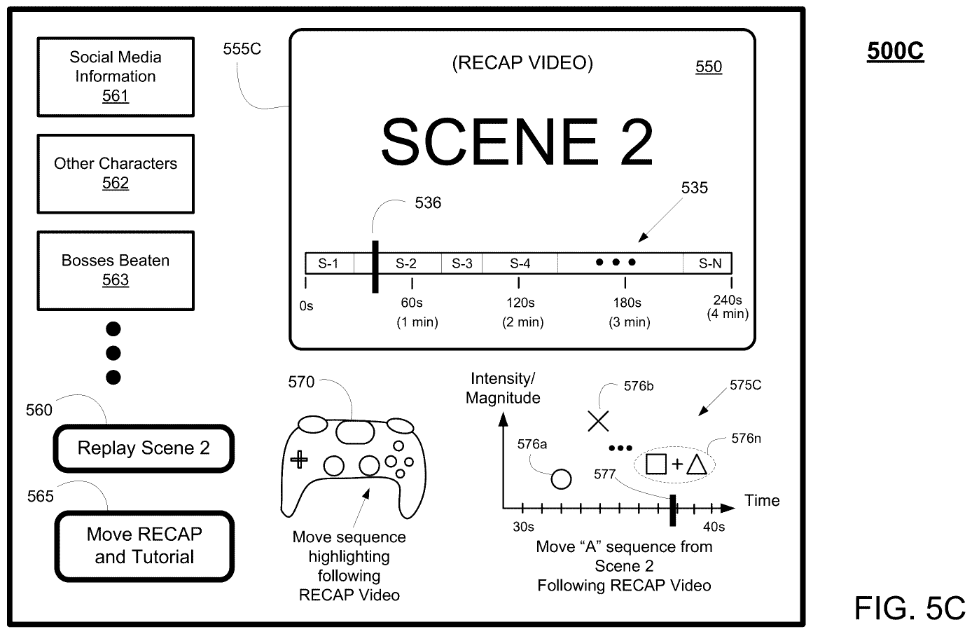

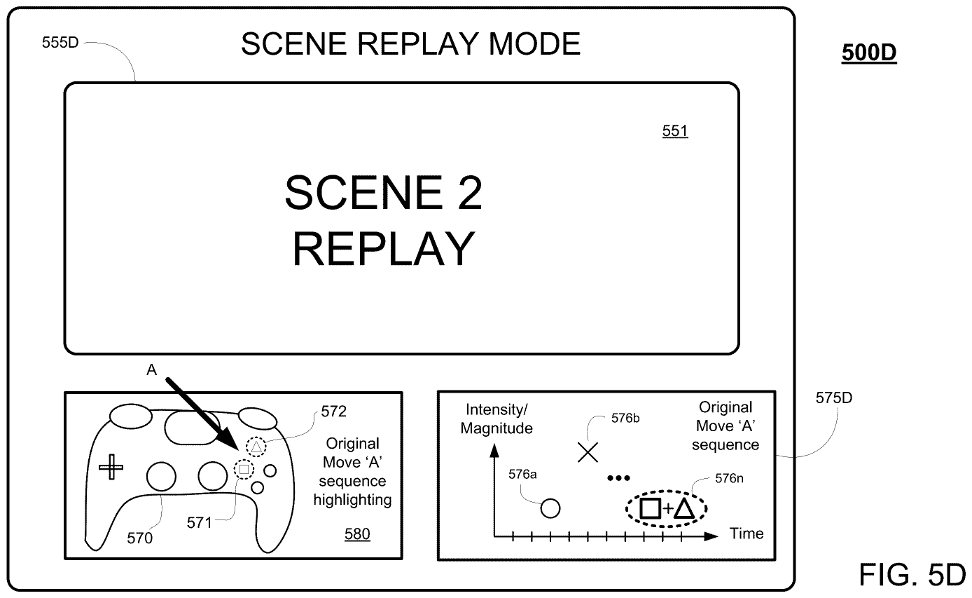

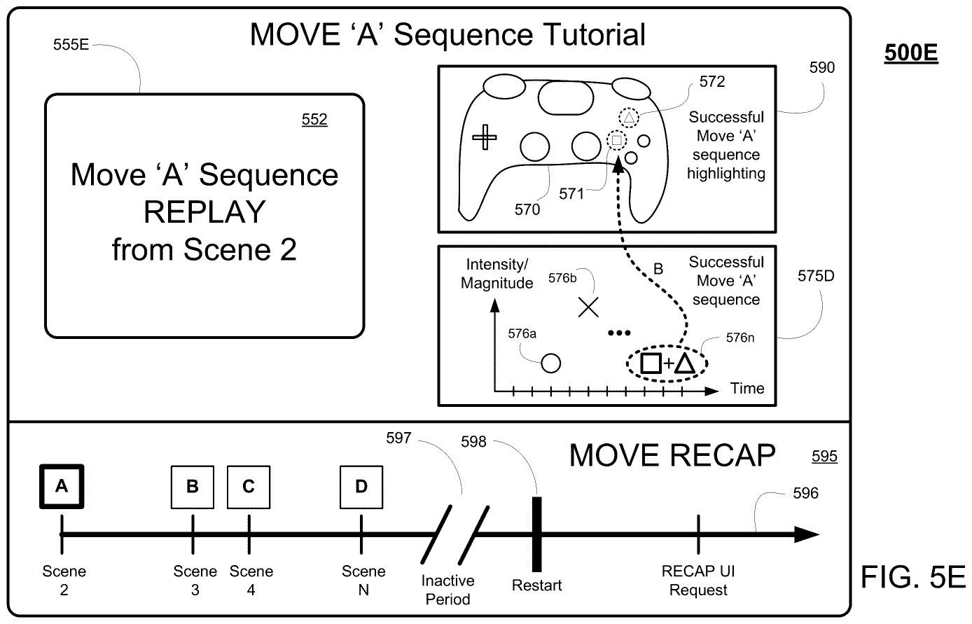

FIG. 5A illustrates a start page 505 for a corresponding video game configured to provide access to one or more recap engine features and/or services, in accordance with one embodiment of the present disclosure. For instance, the start page 505 provides access to a RECAP user interface including a video recapping key events during a game play of a user playing the video game. As shown, the start page 505 is generically shown, and is equally applicable to any video game.

In particular, the start page 505 is configured to allow for launching of one or more corresponding game plays of the video game. The start page 505 allows for interaction by a corresponding user. For example, there may be one or more game plays of the video game, by one or more users. The one or more game plays may be provided under one license of the video game. For illustration purposes only, button or icon 501 allows for launching of game play ‘A’, and button 502 allows for launching of game play ‘B’. As shown, button 501 is selected by the user to launch game play ‘A’ of the video game for interaction by the user.

Start page 505 includes icon or button 510 that is selected by the user to launch and provide access to one or more recap engine services, such as via a recap engine user interface 500 that may be configurable to provide one or more features. In particular, selection of button 510 provides for the generation and display of a splash page 500B for viewing of a user interface in order to access one or more features of the recap engine. A further discussion of a representation of splash page 500B is shown in relation to FIG. 5B. Button 510 provides for an active request to launch the recap user interface, and may be overlaid any screen during the game play of the user. In some implementations, the user may be prompted to launch the recap user interface (e.g., via a query or by presenting button 510), such as when the system detects that the user is having difficulty during their game play, or when the user has not played the video game for a threshold period of time. In other embodiments, the recap user interface is automatically presented to the user upon detection that the user is having difficulty in their game play, or satisfies some other criteria (e.g., not having played over a prolonged period of time, having played multiple other games since the last game play of the video game, etc.).

FIG. 5B illustrates a splash page 500B for a recap user interface, in accordance with one embodiment of the present disclosure. The splash page 500B is configured to allow a user to set one or more parameters of a video recapping game play of a user playing a video game, wherein the video is generated using artificial intelligence. Further, splash page 500B is configured to provide access to the one or more features and/or services of a recap engine, including the video recapping key events of the game play.

Interface 530 allows for selection, by a user, of a length (i.e., in time) for the video recapping key events in the game play of the user. In particular, time bar 531 is configured to show one or more lengths of time that are selectable by the user. For example, the time bar may include one or more increments 532 (e.g., in minutes) to allow for selection of length for a video recapping the key events between 0 to 60 minutes using the slider bar 535. Other ranges for the length in the time bar are supported, such that the time bar may have a shorter selectable range (less than 60 minutes), or longer selectable range (e.g., more than 60 minutes). As shown, the user has selected a length of the recap video of 4 minutes, as indicated by the position of slider bar 535.

As previously described, the selected length of the video dictates how the storyline of the video is curated. For example, the storyline may be more to the point for a short video, whereas a longer video can afford to provide more details of the game play that may be preferable to the user (e.g., provide information on side quests when the user profile indicates the user likes side quests). Further, the length may be adjusted depending on how long ago the user has played the video game, as previously described. In one implementation, once the length is selected, the video recapping the key events in the game play of the user is automatically generated using artificial intelligence, as previously discussed. In another implementation, the video is generated upon selection of the play button 525. Also, selection of play button 525 provides for display of a window showing the video.

In addition, the splash page 500B includes additional information relevant to the game play of the user, wherein the information may be presented in window 540. The information may summarize the game play with the relevant data to help the user recall their game play. For purposes of illustration only, the information may be listed in columns where the category of information is listed in blocks forming a left column, and the data or information for each category is listed in blocks forming a right column. For example, blocks 541 and 542 in combination indicate when the user last played the video game (i.e., 6 months ago); blocks 543 and 544 in combination indicate what the current level is for the game play of the user (i.e., Level 4); blocks 545 and 546 in combination indicate other players the user is interacting with, such as within a multi-player gaming session (i.e., players Starman, gecko-1, Jade, Rvvr, etc.); block 546 and 547 indicate earned achievements by the user in their game play (i.e., weapons earned, trophies earned, unlocked moves, etc.); . . . and blocks 548 and 549 provide a description of the video game (e.g., a general description or overview of the video game, and/or a summary of the game play of the user, and/or a description of the current game context of the game play, etc.). Other information may be listed within window 540.

Splash page 500B includes icon or button 565 that is selectable by the user to launch and provide access to a move tutorial. As previously described, the move tutorial provides instructions on how to execute a move (e.g., sequence of controller inputs), and includes one or more of a textual description of the sequence of controller inputs, a visual representation of the sequence of controller inputs, highlighted buttons on a controller following the sequence of controller inputs, and/or a replay feature allowing the user to practice executing the move through new controller inputs.

FIG. 5C illustrates a recap engine user interface 500C displaying a video 550 recapping game play of a user playing a video game, in accordance with one embodiment of the present disclosure. In particular, the video incorporates scenes from the game play of the user. Also, the user interface 500C provides access to one or more features provided by the recap engine, such as a feature enabling replay of a scene or unlocked move from the game play.

Window 555C displays the video recap 550 that is generated using artificial intelligence. For example, the video recapping key events in the game play of the user may include N scenes, for a selected length of 4 minutes. Scene 2 is being shown at a current point in the video 550. Progress bar 535 indicates which scene in the game play is being shown (i.e., scene 2), and progress bar indicates timing of the video being shown, where timing is made with reference to a start time (i.e., 0 minutes) and an end time (240 seconds or 4 minutes in length). Indicator 536 shows timing for the current point in playing the video. For instance, at a current point scene 2 is being shown after approximately 40 seconds has elapsed in the playing of the video.

User interface 500C also displays information relevant to the video 550 being shown, such as in one or more blocks or windows. In one embodiment, the information is dynamically displayed to be in alignment with each of the plurality of scenes. For example, the information display is relevant to a scene currently being played in the video 550 (e.g., scene 2). For example, the information may include a description of the storyline that is curated, and which may be focused on the current scene being shown (e.g., scene 2); or social media information, such as one or more other players participating in a multi-player gaming session, or participants in an ongoing chat related to the game play, as shown in block 561; or one or more characters in the game play of the video game, as shown in block 562; and one or more bosses beaten in the game play, as shown in block 563; and other relevant information.

In addition, user interface 500C dynamically displaying a plurality of controller input sequences used in the game play of the video game for the plurality of scenes. This reminds the brain on how to execute the scene. For example, graph 575C visually shows the sequence of controller inputs used during the currently shown scene (e.g., scene 2) of the video 550, such as to execute move ‘A’. Graph 575C includes a vertical axis showing magnitude and/or intensity of the controller inputs, and a horizontal axis showing timing of execution of the controller inputs in the sequence. The timing is in alignment with the video 550 and shows controller inputs executed by the user in their game play between 30 and 40 seconds in the playing of the video 550. Currently for scene 2, move ‘A’ is being executed, and graph 575C shows the sequence of controller inputs, including execution, in order, of a “circle” button (input 576a of the sequence) at approximately 32 seconds, an “X” button (input 576b of the sequence) at approximately 35 seconds into the video, . . . and a combination (inputs 576n of the sequence) of “square” plus “triangle” buttons at approximately 38 seconds. The controller inputs may be highlighted to show which input is being executed for the video frame being shown in the video 550. For example, at the current point in the showing of the video 550 (as indicated by indicator 536) at approximately 38 seconds, the combination on controller inputs 576n in the sequence may be highlighted.

Further, graph 575C displays magnitude and/or intensity for each of the controller inputs in the sequence being shown (e.g., for move ‘A’). As previously described, the timing of the controller inputs shown in graph 575C is presented in alignment with the scene currently being played in the video. For each controller input, the position of the controller input in the graph 575C indicates a magnitude and/or intensity for actuating the button corresponding to that controller input. For example, the vertical axis showing magnitude and/or intensity may indicate how long is necessary to engage with the corresponding button, or how many times and how fast to press that button. For example, higher magnitude and/or intensity may indicate a longer engagement time, and/or quick and multiple repetitive button pressing. On the other hand, a lower magnitude and/or intensity may indicate a shorter engagement time, and/or single button press.

In another implementation, one or more controller inputs of a controller input sequence is displayed in alignment with a scene of the plurality of scenes currently being played in the video recapping the game play of the video game. For example, in addition to graph 575C or in substitution of the graph, controller inputs in the sequence are overlaid scene 2 being shown in the video 550.

In another implementation, user interface 500C also shows a controller representation 570 configured to highlight timing of inputs in the sequence of controller inputs. The controller 570 includes a plurality of buttons for entering in one or more controller inputs of the sequence (sequence for move ‘A’). In addition, controller inputs are highlighted with proper timing as executed within the corresponding scene being displayed (e.g., scene 2). That is, one or more controller inputs of the controller input sequence are highlighted in alignment with the scene currently being played in the video 550. In that manner, the user is reminded on input sequences for executing a move, such as move ‘A’.

User interface 500C also includes one or more selectable buttons for accessing additional features and/or services of the recap engine. For example, button 560 is selectable by the user to launch a replay of the scene in the video 550 that is controllable by the user, such as the currently shown scene (e.g., scene 2). As previously described, a subset of game state data corresponding to scene 2 is used to instantiate an instance of the video game to generate a gaming environment at the beginning of scene 2, or at the current point being shown for scene 2. The replay feature hands over control to the user to newly play scene 2. In one embodiment, scene 2 is automatically replayed using previously executed controller inputs until reaching a point selectable by the user for jumping into the replay of the scene (e.g., activate a controller input automatically hands over control). FIG. 5D shows a user interface providing scene replay services.

In addition, button 565 is selectable by the user to launch and provide access to a move tutorial. As previously described, the move tutorial provides instructions on how to execute a move (e.g., corresponding sequence of controller inputs), and includes one or more of a textual description of the sequence of controller inputs, a visual representation of the sequence of controller inputs, highlighted buttons on a controller following the sequence of controller inputs, and/or a replay feature allowing the user to practice executing the move through newly provided controller inputs. The replay feature may launch an instance of the video game for a scene where the user successfully executed the selected move (e.g., move ‘A’), wherein the user is able to practice the move by entering in new controller inputs. FIG. 5E shows a user interface providing move tutorial services.

FIG. 5D illustrates a user interface 500D enabling a replay of a scene taken from a game play of a video game by a user, in accordance with one embodiment of the present disclosure. For example, the user interface 500D may be accessed through selection of button 560 of FIG. 5C.

Window 555D displays the video frames of the replay 551 of a scene in the video 550, wherein the scene is selectable by the user. For example, scene 2 may be playing in the video 550 when the replay feature is selected, and indicates that the user wishes to replay scene 2. As previously describes, an instance of the video game is instantiated using corresponding game state data to replicate a gaming environment at the beginning of scene 2, or at any point of scene 2 shown in the video 550. User is able to jump in and control the play of scene 2. The replay of the scene is displayed in window 555D.

While the user is actively replaying the scene, graph 575D may show controller inputs used during the original game play. Graph 575D may be similar to graph 575C, and displays timing as well as magnitude and/or intensity for each of the controller inputs in the sequence being shown for a corresponding move (e.g., for move ‘A’). For example, previously executed controller inputs for a sequence of a move (e.g., move ‘A’) may include input 576a, input 576b, . . . and a combination of inputs 576n. In that manner, the user is able to see how the user played the game before. This is helpful when the user is unsuccessful in playing the scene.

Also window 580 shows user interface 500D configured to display a controller representation 570 including a plurality of buttons for entering in the one or more controller inputs of the controller input sequence. The controller is configured to highlight timing of inputs previously used in the game play for a corresponding controller input sequence (e.g., for move ‘A’), which is in alignment with the scene currently being replayed taken from the video 550 recapping the game play of the video game. In particular, controller inputs are highlighted with timing as executed previously in the game play for scene 2. The controller input sequence being highlighted may corresponding with a successful execution of the corresponding move. Further, one or more controller inputs of the controller input sequence are highlighted in close alignment with the scene being replayed. For instance, timing arrow “A” indicates that the combination of the square button 571 and the triangle button 572 should be pressed for a successful execution of the move. In that manner, the user is able to see timing for a successful execution of the move, such as move ‘A’.

FIG. 5E illustrates a user interface 500E enabling a replay and tutorial of a move unlocked during a game play of a video game by a user, in accordance with one embodiment of the present disclosure. Progress bar 596 provides selection by the user to replay any of the moves that are displayed in a tutorial. For example, move A from scene 2 is selected by the user, as indicated by the bolded box. The tutorial is used to remind the user on how to implement the move, such as move ‘A’ as a representative example. That is, the tutorial activates twitch memory of the user when performing the move. For example, the user interface 500E may be accessed through selection of button 565 of FIG. 5C, and indicates a request to replay a move. In addition, user interface 500E may be presented within the user interface 500C, such as via a window or sandbox, and may be shown alongside the video 550 being played. In another implementation, user interface 500E is displayed in isolation for better viewing.

In one embodiment, user interface 500E, or access to the interface (e.g., via button 565), may be prompted or suggested to the user. For example, detection of difficulty by the user (e.g., difficulty in progressing through the game play of the video game, or through a scene, or difficulty when executing an unlocked move, or failure to implement a required move for a corresponding scene, or not using full complement of unlocked moves, etc.) may trigger display one or more of the user interface 500E, or progress bar 595, or the button 565 providing access to a replay move feature of the user interface 500E.

Window 555E displays the video frames of the replay 552 of a move (e.g., move ‘A’), wherein the move is selectable by the user. As previously described, an instance of the video game is instantiated using corresponding game state data to replicate a gaming environment of a scene where the move was successfully executed, or newly unlocked. The user is able to jump in and newly control the execution of the move.

While the user is actively replaying the move, graph 575D may show controller inputs used during the original game play. Graph 575D was previously described in relation to FIG. 5D, and displays timing as well as magnitude and/or intensity for each of the controller inputs in the sequence being shown for a corresponding move (e.g., for move ‘A’). For example, previously executed controller inputs for a sequence of a move (e.g., move ‘A’) may include input 576a, input 576b, . . . and a combination of inputs 576n. In that manner, the user is able to see how the user played the game before.

Also window 590 is configured to display a controller representation 570 including a plurality of buttons for entering in the one or more controller inputs of the controller input sequence. The controller is configured to highlight timing of inputs previously used in the game play for a corresponding controller input sequence (e.g., for move ‘A’) from the selected scene (e.g., where the move was unlocked). In particular, controller inputs are highlighted with timing as successfully executed. Further, one or more controller inputs of the controller input sequence are highlighted in close alignment with the move being replayed. For instance, timing arrow “B” indicates that input 576n, including the combination of the square button 571 and the triangle button 572, should be executed for a successful execution of the move. In another embodiment, an button timing is overlaid the replay of the move to show successful execution of the move (e.g., move ‘A’).

In that manner, the user is able to see timing for a successful execution of the move, such as move ‘A’. Further, a ghost mode of a character being controlled through the execution of move ‘A’ may be overlaid the character being controlled in the replay of the move. That is, a shadow clone of the character is shown successfully executing the move. In that manner, the user is able to see how the character reacts during a successful execution of the move being replayed. For example, the user is able to see if their timing is spot on, too fast, and/or too slow throughout the sequence.

User interface 500E shows a move recap interface 595 configured to display one or more moves previously unlocked during the game play of the user. For example, progress bar 596 may indicate timing of when moves where unlocked during the game play. Progress bar also shows when the game was restarted at point 598, such as after a period of inactivity 597, and when the user requested to replay a move after the restart.

As shown in the progress bar 596, one or more moves have been unlocked, including move A corresponding with scene 2 in the replay video 550, move B corresponding with scene 3, move C corresponding with scene 4, and move D corresponding with scene N. Not all moves may be shown. In one implementation, a hierarchy of moves controls which moves are shown in progress bar. For example, more important moves may be displayed in progress bar over less important moves. Further, moves are shown depending on how recently the video game was played by the user. For example, if the period of inactivity is long, then the progress bar includes recently unlocked moves. Older moves may have lower priority, as they may be more ingrained in the mind of the user and twitch memory. On the other hand, if the period of inactivity is short, then recently unlocked moves are probably remembered by the user. The progress bar may include moves with higher importance and/or more critical moves, such as moves that are necessary to progress forward through the game.

In one embodiment, game plays of multiple players are analyzed to determine which moves are placed into progress bar. For example, a histogram of moves up to the current point in the game play of the user is generated. The histogram can determine which moves are highly used by all players or in the game play of the user (e.g., the eighty percent of moves that the user makes, or that all players make). The histogram indicates which moves are least used, such as the twenty percent of moves that are not used much by the user and/or all players. The progress bar may include moves that are less likely to be used, as these may be the moves used my players that are experts and/or more likely to successfully complete the video game.

In one embodiment, moves shown in progress bar 595 are selected based on difficulty setting (level set) for playing the video game, as selected by the user. For example, depending on the level set, maybe the 20 percent of moves are not required for successfully completing the video game (e.g., when the level set is low, such as for beginners). On the other hand, for a high level set (i.e., very difficult), maybe the 20 percent of moves are necessary to complete the video game, as these moves are used by a few gamers that definitely complete the game, such as by experts.

In one embodiment, user interface 500E may include a success meter configured to indicate how well the user is executing the move being replayed. The success meter may be dynamically changing throughout the course of execution of the move.

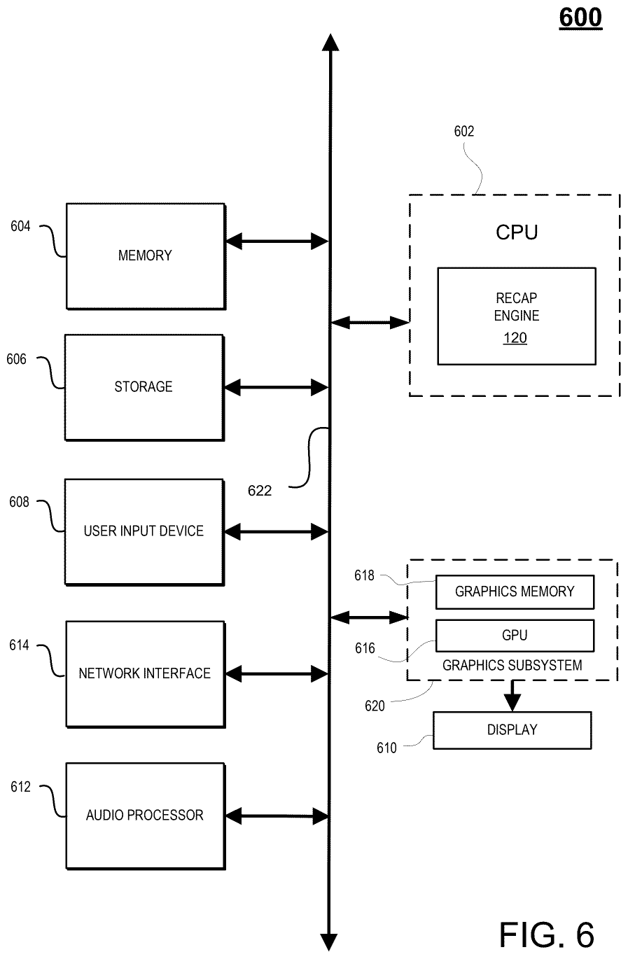

FIG. 6 illustrates components of an example device 600 that can be used to perform aspects of the various embodiments of the present disclosure. This block diagram illustrates a device 600 that can incorporate or can be a personal computer, video game console, handheld video game console, personal digital assistant, a server or other digital device, and includes a central processing unit (CPU) 602 for running software applications and optionally an operating system. CPU 602 may be comprised of one or more homogeneous or heterogeneous processing cores. Further embodiments can be implemented using one or more CPUs with microprocessor architectures specifically adapted for highly parallel and computationally intensive applications.

In particular, CPU 602 may be configured to implement a recap engine 120 that is configured to provide services that help a user recall their game play of a video game using artificial intelligence. For example, the services include generating a video recapping key events in their game play, wherein the artificial intelligence is configured to identify the key events, curating a storyline unique to the game play of the user, generate a video recapping those key events that follows the curated storyline. Other services include enabling replay of one or more scenes presented in the video recap, wherein the video recap provides an jump point to the replay functionality. Still other services include generating a tutorial that enables the user to replay one or more moves learned and/or unlocked during the game play of the video game by the user. In that manner, the user is able to jump back into the game play of the video without feeling lost within the game, such as when picking up a video game after a prolonged period of inactivity.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs. In one embodiment, GPU 616 may be implemented within an AI engine (e.g., machine learning engine 195) to provide additional processing power, such as for the AI, machine learning functionality, or deep learning functionality, etc.

The graphics subsystem 620 periodically outputs pixel data for an image from graphics memory 618 to be displayed on display device 610. Display device 610 can be any device capable of displaying visual information in response to a signal from the device 600.

In other embodiments, the graphics subsystem 620 includes multiple GPU devices, which are combined to perform graphics processing for a single application that is executing on a CPU. For example, the multiple GPUs can perform alternate forms of frame rendering, including different GPUs rendering different frames and at different times, different GPUs performing different shader operations, having a master GPU perform main rendering and compositing of outputs from slave GPUs performing selected shader functions (e.g., smoke, river, etc.), different GPUs rendering different objects or parts of scene, etc. In the above embodiments and implementations, these operations could be performed in the same frame period (simultaneously in parallel), or in different frame periods (sequentially in parallel).

Accordingly, in various embodiments the present disclosure describes systems and methods configured for providing services that help a user recall their game play of a video game using artificial intelligence, including generating a video recap of key events in the game play that incorporates scenes from that game play, including recapping important moves unlocked during the game play; and for enabling replay of one or more scenes from the game play (as introduced through the video recap); and for enabling a tutorial enabling replay of one or more moves unlocked during the game play.

It should be noted, that access services, such as providing access to games of the current embodiments, delivered over a wide geographical area often use cloud computing. Cloud computing is a style of computing in which dynamically scalable and often virtualized resources are provided as a service over the Internet. For example, cloud computing services often provide common applications (e.g., video games) online that are accessed from a web browser, while the software and data are stored on the servers in the cloud.

A game server may be used to perform operations for video game players playing video games over the internet, in some embodiments. In a multiplayer gaming session, a dedicated server application collects data from players and distributes it to other players. The video game may be executed by a distributed game engine including a plurality of processing entities (PEs) acting as nodes, such that each PE executes a functional segment of a given game engine that the video game runs on. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. The PEs may be virtualized by a hypervisor of a particular server, or the PEs may reside on different server units of a data center. Respective processing entities for performing the operations may be a server unit, a virtual machine, or a container, GPU, CPU, depending on the needs of each game engine segment. By distributing the game engine, the game engine is provided with elastic computing properties that are not bound by the capabilities of a physical server unit. Instead, the game engine, when needed, is provisioned with more or fewer compute nodes to meet the demands of the video game.

Users access the remote services with client devices (e.g., PC, mobile phone, etc.), which include at least a CPU, a display and I/O, and are capable of communicating with the game server. It should be appreciated that a given video game may be developed for a specific platform and an associated controller device. However, when such a game is made available via a game cloud system, the user may be accessing the video game with a different controller device, such as when a user accesses a game designed for a gaming console from a personal computer utilizing a keyboard and mouse. In such a scenario, an input parameter configuration defines a mapping from inputs which can be generated by the user's available controller device to inputs which are acceptable for the execution of the video game.

In another example, a user may access the cloud gaming system via a tablet computing device, a touchscreen smartphone, or other touchscreen driven device, where the client device and the controller device are integrated together, with inputs being provided by way of detected touchscreen inputs/gestures. For such a device, the input parameter configuration may define particular touchscreen inputs corresponding to game inputs for the video game (e.g., buttons, directional pad, gestures or swipes, touch motions, etc.).

In some embodiments, the client device serves as a connection point for a controller device. That is, the controller device communicates via a wireless or wired connection with the client device to transmit inputs from the controller device to the client device. The client device may in turn process these inputs and then transmit input data to the cloud game server via a network. For example, these inputs might include captured video or audio from the game environment that may be processed by the client device before sending to the cloud game server. Additionally, inputs from motion detection hardware of the controller might be processed by the client device in conjunction with captured video to detect the position and motion of the controller before sending to the cloud gaming server.

In other embodiments, the controller can itself be a networked device, with the ability to communicate inputs directly via the network to the cloud game server, without being required to communicate such inputs through the client device first, such that input latency can be reduced. For example, inputs whose detection does not depend on any additional hardware or processing apart from the controller itself can be sent directly from the controller to the cloud game server. Such inputs may include button inputs, joystick inputs, embedded motion detection inputs (e.g., accelerometer, magnetometer, gyroscope), etc.

Access to the cloud gaming network by the client device may be achieved through a network implementing one or more communication technologies. In some embodiments, the network may include 5th Generation (5G) wireless network technology including cellular networks serving small geographical cells. Analog signals representing sounds and images are digitized in the client device and transmitted as a stream of bits. 5G wireless devices in a cell communicate by radio waves with a local antenna array and low power automated transceiver. The local antennas are connected with a telephone network and the Internet by high bandwidth optical fiber or wireless backhaul connection. A mobile device crossing between cells is automatically transferred to the new cell. 5G networks are just one communication network, and embodiments of the disclosure may utilize earlier generation communication networks, as well as later generation wired or wireless technologies that come after 5G.

In one embodiment, the various technical examples can be implemented using a virtual environment via a head-mounted display (HMD), which may also be referred to as a virtual reality (VR) headset. As used herein, the term generally refers to user interaction with a virtual space/environment that involves viewing the virtual space through an HMD in a manner that is responsive in real-time to the movements of the HMD (as controlled by the user) to provide the sensation to the user of being in the virtual space or metaverse. An HMD can be worn in a manner similar to glasses, goggles, or a helmet, and is configured to display a video game or other metaverse content to the user. The HMD can provide a very immersive experience in a virtual environment with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures (e.g., commands, communications, pointing and walking toward a particular content item in the scene, etc.). In one embodiment, the gestures can be tracked and processed by the system to generate a prediction of interaction with the particular content item in the game scene. In some embodiments, machine learning may be used to facilitate or assist in the prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network, such as internet, cellular, etc. In one embodiment, the cloud computing and gaming system maintains and executes the video game being played by the user. In some embodiments, the cloud computing and gaming system is configured to receive inputs from the HMD and/or interfacing objects over the network. The cloud computing and gaming system is configured to process the inputs to affect the game state of the executing video game. The output from the executing video game, such as video data, audio data, and haptic feedback data, is transmitted to the HMD and the interface objects.

Additionally, though implementations in the present disclosure may be described with reference to an HMD, it will be appreciated that in other implementations, non-HMDs may be substituted, such as, portable device screens (e.g., tablet, smartphone, laptop, etc.) or any other type of display that can be configured to render video and/or provide for display of an interactive scene or virtual environment. It should be understood that the various embodiments defined herein may be combined or assembled into specific implementations using the various features disclosed herein. Thus, the examples provided are just some possible examples, without limitation to the various implementations that are possible by combining the various elements to define many more implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

With the above embodiments in mind, it should be understood that embodiments of the present disclosure can employ various computer-implemented operations involving data stored in computer systems. These operations are those requiring physical manipulation of physical quantities. Any of the operations described herein in embodiments of the present disclosure are useful machine operations. Embodiments of the disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server, or by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator that emulates a processing system.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method, comprising:
accessing a plurality of game state data for a game play of a video game;
executing an artificial intelligence (AI) model using the game state data to identify a plurality of key events in the game play of the video game;
executing the AI model using the game state data to curate a storyline for a video recapping the game play of the video game, wherein the storyline is curated for a selected duration;
executing the AI model using the game state data to select and arrange a plurality of scenes from the game play of the video game following the storyline that is curated, wherein each of the plurality of scenes includes one or more video frames from the game play of the video game;
regenerating the plurality of scenes using the game state of the game play of the video game;
executing the AI model to generate the video recapping the game play of the video game including the plurality of scenes arranged to follow the storyline that is curated; and
displaying the video recapping the game play of the video game in a user interface.

2. The method of claim 1, further comprising:
receiving a request by a user for the video recapping the game play of the video game.

3. The method of claim 1, wherein the regenerating the plurality of scenes includes:
executing an instance of the video game using the game state data to replay the plurality of scenes from the game play of the video game.

4. The method of claim 3, further comprising:
identifying a subset of the game state data corresponding to a scene in the plurality of scenes; and
executing the instance of the video game using the subset of the game state data to regenerate one or more video frames for the scene.

5. The method of claim 1, further comprising:
capturing a plurality of audio segments broadcast during a plurality of game plays of the video game by a plurality of users;
curating an audio track including the plurality of audio segments following the storyline that is curated; and
adding the audio track that is curated to the video recapping the game play of the video game in alignment with the plurality of scenes following the storyline that is curated.

6. The method of claim 1, further comprising:
dynamically displaying information in a window of the user interface along with the video recapping the game play of the video game, wherein the information being displayed is in alignment with one of the plurality of scenes currently being played in the video recapping the game play of the video game, wherein the information includes at least one of the following:
a description of the storyline that is curated; or
one or more other players participating in a multi-player gaming session; and
one or more characters in the game play of the video game; and
one or more bosses beaten in the game play; and
one or more unlocked moves; and
one or more achievements; and
one or more weapons earned; and
one or more trophies earned.

7. The method of claim 1, further comprising:
dynamically displaying a plurality of controller input sequences used in the game play of the video game for the plurality of scenes,
wherein the plurality of controller input sequences is displayed in a window of the user interface along with the video recapping the game play of the video game,
wherein one or more controller inputs of a controller input sequence is displayed in alignment with a scene of the plurality of scenes currently being played in the video recapping the game play of the video game.

8. The method of claim 7, further comprising:
displaying magnitude and timing for each of the one or more controller inputs of the controller input sequence in alignment with the scene currently being played in the video recapping the game play of the video game.

9. The method of claim 7, further comprising:
displaying a controller including a plurality of buttons for entering in the one or more controller inputs of the controller input sequence; and
highlighting the one or more controller inputs of the controller input sequence in alignment with the scene currently being played in the video recapping the game play of the video game.

10. The method of claim 1, further comprising:
receiving a request to replay a scene from the plurality of scenes;
initiating an instance of the video game beginning from a start of the scene using a subset of the game state data corresponding to the scene, wherein the instance of the video game is controllable by a user; and
displaying the scene that is being replayed and controlled by the user in a window of the user interface.

11. The method of claim 1, further comprising:
receiving a request to replay a move from a scene in the plurality of scenes, wherein the move was successfully completed;
initiating an instance of the video game beginning from a start of the move using a subset of the game state data corresponding to the move in the scene, wherein the instance of the video game is controllable by a user;
displaying the scene from the start of the move that is being replayed and controlled by the user in a window of the user interface;
displaying one or more controller inputs for a controller input sequence corresponding to the move that was successfully accomplished in the scene; and
displaying magnitude and timing for each of the one or more controller inputs of the controller input sequence in alignment with the move that was successfully completed in the game play of the video game.

12. The method of claim 1, further comprising:
interleaving a filler scene with the plurality of scenes following the storying line that is curated for the video recapping the game play of the video game,
wherein the filler scene is taken from a plurality of filler scenes generated from a plurality of game plays of the video game.

13. A computer system comprising:
a processor; and
memory coupled to the processor and having stored therein instructions that, if executed by the computer system, cause the computer system to execute a method comprising:
accessing a plurality of game state data for a game play of a video game;
executing an artificial intelligence (AI) model using the game state data to identify a plurality of key events in the game play of the video game;
executing the AI model using the game state data to curate a storyline for a video recapping the game play of the video game, wherein the storyline is curated for a selected duration;
executing the AI model using the game state data to select and arrange a plurality of scenes from the game play of the video game following the storyline that is curated, wherein each of the plurality of scenes includes one or more video frames from the game play of the video game;
regenerating the plurality of scenes using the game state of the game play of the video game;
executing the AI model to generate the video recapping the game play of the video game including the plurality of scenes arranged to follow the storyline that is curated; and
displaying the video recapping the game play of the video game in a user interface.

14. The computer system of claim 13, wherein in the method the regenerating the plurality of scenes includes:
executing an instance of the video game using the game state data to replay the plurality of scenes from the game play of the video game;
identifying a subset of the game state data corresponding to a scene in the plurality of scenes; and
executing the instance of the video game using the subset of the game state data to regenerate one or more video frames for the scene.

15. The computer system of claim 13, the method further comprising:
dynamically displaying a plurality of controller input sequences used in the game play of the video game for the plurality of scenes,
wherein the plurality of controller input sequences is displayed in a window of the user interface along with the video recapping the game play of the video game,
wherein one or more controller inputs of a controller input sequence is displayed in alignment with a scene of the plurality of scenes currently being played in the video recapping the game play of the video game.

16. The computer system of claim 15, the method further comprising:
displaying a controller including a plurality of buttons for entering in the one or more controller inputs of the controller input sequence; and
highlighting the one or more controller inputs of the controller input sequence in alignment with the scene currently being played in the video recapping the game play of the video game.

17. The computer system of claim 13, the method further comprising:
receiving a request to replay a move from a scene in the plurality of scenes, wherein the move was successfully completed;
initiating an instance of the video game beginning from a start of the move using a subset of the game state data corresponding to the move in the scene, wherein the instance of the video game is controllable by a user;
displaying the scene from the start of the move that is being replayed and controlled by the user in a window of the user interface;
displaying one or more controller inputs for a controller input sequence corresponding to the move that was successfully accomplished in the scene; and
displaying magnitude and timing for each of the one or more controller inputs of the controller input sequence in alignment with the move that was successfully completed in the game play of the video game.

18. A non-transitory computer-readable medium storing a computer program for performing a method, the computer-readable medium comprising:
program instructions for accessing a plurality of game state data for a game play of a video game;
program instructions for executing an artificial intelligence (AI) model using the game state data to identify a plurality of key events in the game play of the video game;
program instructions for executing the AI model using the game state data to curate a storyline for a video recapping the game play of the video game, wherein the storyline is curated for a selected duration;
program instructions for executing the AI model using the game state data to select and arrange a plurality of scenes from the game play of the video game following the storyline that is curated, wherein each of the plurality of scenes includes one or more video frames from the game play of the video game;
program instructions for regenerating the plurality of scenes using the game state of the game play of the video game;
program instructions for executing the AI model to generate the video recapping the game play of the video game including the plurality of scenes arranged to follow the storyline that is curated; and
program instructions for displaying the video recapping the game play of the video game in a user interface.

19. The non-transitory computer-readable medium of claim 18, wherein the program instructions for regenerating the plurality of scenes includes:
program instructions for executing an instance of the video game using the game state data to replay the plurality of scenes from the game play of the video game;
program instructions for identifying a subset of the game state data corresponding to a scene in the plurality of scenes; and
program instructions for executing the instance of the video game using the subset of the game state data to regenerate one or more video frames for the scene.

20. The non-transitory computer-readable medium of claim 18, further comprising:
program instructions for receiving a request to replay a move from a scene in the plurality of scenes, wherein the move was successfully completed;
program instructions for initiating an instance of the video game beginning from a start of the move using a subset of the game state data corresponding to the move in the scene, wherein the instance of the video game is controllable by a user;
program instructions for displaying the scene from the start of the move that is being replayed and controlled by the user in a window of the user interface;
program instructions for displaying one or more controller inputs for a controller input sequence corresponding to the move that was successfully accomplished in the scene; and
program instructions for displaying magnitude and timing for each of the one or more controller inputs of the controller input sequence in alignment with the move that was successfully completed in the game play of the video game.
